(19) United States
(12) Patent Application Publication
(10) Pub. No.: US 2025/0084759 A1
(43) Pub. Date: Mar. 13, 2025

(54) FLUORESCENT DYE OIL TRACER COMPOSITIONS

(71) Applicant: Saudi Arabian Oil Company, Dhahran (SA)

(72) Inventor: Wei Wang, Quincy, MA (US)

(21) Appl. No.: 18/958,069

(22) Filed: Nov. 25, 2024

Related U.S. Application Data
(62) Division of application No. 17/835,676, filed on Jun. 8, 2022, now Pat. No. 12,188,350.

(51) Int. Cl. E21B 47/11; C09B 6/00; C09B 57/00; C09B 57/08; C09K 8/035; C09K 8/62; C09K 11/06

(52) U.S. Cl. CPC E21B 47/11; C09B 6/00; C09B 57/001; C09B 57/08; C09K 8/035; C09K 8/62; C09K 11/06; C09K 2211/1011

(57) ABSTRACT

A composition includes a functionalized fluorescent dye. The functionalized fluorescent dye includes an isothiocyanate-containing compound functionalized with a functional group. The functional group includes a primary amine. The functionalized fluorescent dye can be mixed with a fluid to form a tracer fluid for tracing fluid flow in a subterranean formation.

### CROSS-REFERENCE TO RELATED PATENT APPLICATIONS

This application is a divisional of and claims the benefit of priority to U.S. patent application Ser. No. 17/835,676, filed Jun. 8, 2022, the contents of which are incorporated by reference herein.

### TECHNICAL FIELD

This disclosure relates to methods and compositions used in generating and using functionalized fluorescent tracers with barcoded structures in drilling and oil well applications.

### BACKGROUND

Tracer techniques can be a powerful diagnostic tool in numerous scientific disciplines and for technologies in many industrial sectors. Molecular tracers can include water-soluble or oil-soluble compounds. In field tests of oilfields, water-soluble tracers can provide a better understanding of the studied oil reservoir, for example, a better understanding of inter-well connections, connections between layers and heterogeneities. Similarly, oil-soluble tracers can provide information on petroleum products, for example qualitative analysis of the production fluid return from multiple stage completions, either vertical or horizontal completions.

### SUMMARY

This disclosure describes technologies relating to functionalized fluorescent tracers with barcoded structures, methods of making the tracers, and methods of using the tracers. Certain aspects of the subject matter described can be implemented as a composition. The composition includes a functionalized fluorescent dye. The functionalized fluorescent dye includes an isothiocyanate-containing compound functionalized with a functional group. The functional group includes a primary amine. The isothiocyanate-containing compound is selected from the group consisting of methyl isothiocyanate, ethyl isothiocyanate, propyl isothiocyanate, isopropyl isothiocyanate, butyl isothiocyanate, tert-butyl isothiocyanate, hexyl isothiocyanate, octyl isothiocyanate, decyl isothiocyanate, dodectyl isothiocyanate, tetradecyl isothiocyanate, hexadecyl isothiocyanate, octadecyl isothiocyanate, phenyl isothiocyanate, benzyl isothiocyanate, phenylethyl isothiocyanate, cyclohexyl isothiocyanate, cyclohexylmethyl isothiocyanate, 2-piperidinoethyl isothiocyanate, p-tolyl isothiocyanate, 2,6-dimethylphenyl isothiocyanate, 4-ethyphenyl isothiocyanate, 4-methoxyphenyl isothiocyanate, 2,4-dimethoxyphenyl isothiocyanate, 4-chlorophenyl isothiocyanate, 2,6-dichlorophenyl isothiocyanate, 2,4,5-trichlorophenyl isothiocyanate, 3-bromophenyl isothiocyanate, 2,5-dibromophenyl isothiocyanate, 2,4,6-tribromophenyl isothiocyanate, 3-fluorophenyl isothiocyanate, 2,6-difluorophenyl isothiocyanate, 2,4,6-trifluorophenyl isothiocyanate, 4-(trifluoromethyl)phenyl isothiocyanate, 3,5-bis(trifluoromethyl)phenyl isothiocyanate, 2-chloro-5-(trifluoromethyl)phenyl isothiocyanate, 4-bromo-2-(trifluoromethyl)phenyl isothiocyanate, 4-fluoro-3-(trifluoromethyl)phenyl isothiocyanate, 3-chloro-4-fluorophenyl isothiocyanate, 2-bromo-4-fluorophenyl isothiocyanate, or 4-bromo-2-chlorophenyl isothiocyanate, or any isoform thereof. The functional group is selected from the group consisting of 1-naphthylamine, 2-aminoanthracene, 1-aminopyrene, 6-chrysenamine, 9-aminophenanthrene, 2-aminofluorene, 9-aminoacridine, 1,10-phenanthrolin-5-amine, 9H-carbazol-2-amine, or 3-amino-9-ethylcarbazole.

This, and other aspects, can include one or more of the following features. The isothiocyanate-containing compound can be cyclohexylmethyl isothiocyanate, and the functional group can be 1-naphthylamine. The isothiocyanate-containing compound can be 2,6-difluorophenyl isothiocyanate, and the functional group can be 2-aminoanthracene. The isothiocyanate-containing compound can be 4-ethylphenyl isothiocyanate, and the functional group can be 1-aminopyrene. The isothiocyanate-containing compound can be hexyl isothiocyanate, and the functional group can be 6-chyrsenamine. The isothiocyanate-containing compound can be butyl isothiocyanate, and the functional group can be 9-aminophenanthrene. The isothiocyanate-containing compound can be ethyl isothiocyanate, and the functional group can be 1-aminofluorene. The isothiocyanate-containing compound can be decyl isothiocyanate, and the functional group can be 9-aminoacridine. The isothiocyanate-containing compound can be benzyl isothiocyanate, and the functional group can be 1,10-phenanthrolin-5-amine. The isothiocyanate-containing compound can be p-tolyl isothiocyanate, and the functional group can be 3-amino-9-ethylcarbazole.

Certain aspects of the subject matter described can be implemented as a method of making a functionalized fluorescent dye. The method includes dissolving an oil-soluble isothiocyanate-containing compound in a first portion of a first organic solvent to yield a first solution. The oil-soluble isothiocyanate-containing compound is selected from the group consisting of methyl isothiocyanate, ethyl isothiocyanate, propyl isothiocyanate, isopropyl isothiocyanate, butyl isothiocyanate, tert-butyl isothiocyanate, hexyl isothiocyanate, octyl isothiocyanate, decyl isothiocyanate, dodectyl isothiocyanate, tetradecyl isothiocyanate, hexadecyl isothiocyanate, octadecyl isothiocyanate, phenyl isothiocyanate, benzyl isothiocyanate, phenylethyl isothiocyanate, cyclohexyl isothiocyanate, cyclohexylmethyl isothiocyanate, 2-piperidinoethyl isothiocyanate, p-tolyl isothiocyanate, 2,6-dimethylphenyl isothiocyanate, 4-ethylphenyl isothiocyanate, 4-methoxyphenyl isothiocyanate, 2,4-dimethoxyphenyl isothiocyanate, 4-chlorophenyl isothiocyanate, 2,6-dichlorophenyl isothiocyanate, 2,4,5-trichlorophenyl isothiocyanate, 3-bromophenyl isothiocyanate, 2,5-dibromophenyl isothiocyanate, 2,4,6-tribromophenyl isothiocyanate, 3-fluorophenyl isothiocyanate, 2,6-difluorophenyl isothiocyanate, 2,4,6-trifluorophenyl isothiocyanate, 4-(trifluoromethyl)phenyl isothiocyanate, 3,5-bis(trifluoromethyl)phenyl isothiocyanate, 2-chloro-5-(trifluoromethyl)phenyl isothiocyanate, 4-bromo-2-(trifluoromethyl)phenyl isothiocyanate, 4-fluoro-3-(trifluoromethyl)phenyl isothiocyanate, 3-chloro-4-fluorophenyl isothiocyanate, 2-bromo-4-fluorophenyl isothiocyanate, or 4-bromo-2-chlorophenyl isothiocyanate, or any isoform thereof. The method includes dissolving a functional group in a second portion of the first organic solvent to yield a second solution. The functional group includes a primary amine and is selected from the group consisting of 1-naphthylamine, 2-aminoanthracene, 1-aminopyrene, 6-chrysenamine, 9-aminophenanthrene, 2-aminofluorene, 9-aminoacridine, 1,10-phenanthrolin-5-amine, 9H-carbazol-2-amine, or 3-amino-9-ethylcarbazole. The method includes mixing the first solution and the second solution to form a reaction mixture. The method includes extracting the functionalized fluorescent dye from the reaction mixture. The functionalized fluorescent dye is a reaction product of the oil-soluble isothiocyanate-containing compound and the functional group.

This, and other aspects, can include one or more of the following features. The first organic solvent can include methanol, ethanol, propanol, isopropanol, chloroform, dichloromethane, acetone, cyclohexane, hexane, benzene, toluene or any combination thereof. Extracting the functionalized fluorescent dye from the reaction mixture can include evaporating the first organic solvent. The method can include re-dispersing the functionalized fluorescent dye in a second organic solvent after extracting the functionalized fluorescent dye from the reaction mixture. The second organic solvent can include crude oil, diesel, mineral oil, food oil, methanol, ethanol, propanol, isopropanol, butanol, pentanol, hexanol, heptanol, octenol, acetone, ethyl acetate, acetonitrile, chloroform, hexane, heptane, cyclohexane, benzene, toluene, tetrahydrofuran, or any combination thereof. The second organic solvent can have a composition different from the composition of the first organic solvent.

Certain aspects of the subject matter described can be implemented as a method of tracing fluid flow in a subterranean formation. The method includes mixing a functionalized fluorescent tracer and a fluid to form a tracer fluid. The functionalized fluorescent tracer includes an isothiocyanate-containing compound functionalized with a functional group. The functional group includes a primary amine. The isothiocyanate-containing compound is selected from the group consisting of methyl isothiocyanate, ethyl isothiocyanate, propyl isothiocyanate, isopropyl isothiocyanate, butyl isothiocyanate, tert-butyl isothiocyanate, hexyl isothiocyanate, octyl isothiocyanate, decyl isothiocyanate, dodectyl isothiocyanate, tetradecyl isothiocyanate, hexadecyl isothiocyanate, octadecyl isothiocyanate, phenyl isothiocyanate, benzyl isothiocyanate, phenylethyl isothiocyanate, cyclohexyl isothiocyanate, cyclohexylmethyl isothiocyanate, 2-piperidinoethyl isothiocyanate, p-tolyl isothiocyanate, 2,6-dimethylphenyl isothiocyanate, 4-ethyphenyl isothiocyanate, 4-methoxyphenyl isothiocyanate, 2,4-dimethoxyphenyl isothiocyanate, 4-chlorophenyl isothiocyanate, 2,6-dichlorophenyl isothiocyanate, 2,4,5-trichlorophenyl isothiocyanate, 3-bromophenyl isothiocyanate, 2,5-dibromophenyl isothiocyanate, 2,4,6-tribromophenyl isothiocyanate, 3-fluorophenyl isothiocyanate, 2,6-difluorophenyl isothiocyanate, 2,4,6-trifluorophenyl isothiocyanate, 4-(trifluoromethyl)phenyl isothiocyanate, 3,5-bis(trifluoromethyl)phenyl isothiocyanate, 2-chloro-5-(trifluoromethyl)phenyl isothiocyanate, 4-bromo-2-(trifluoromethyl)phenyl isothiocyanate, 4-fluoro-3-(trifluoromethyl)phenyl isothiocyanate, 3-chloro-4-fluorophenyl isothiocyanate, 2-bromo-4-fluorophenyl isothiocyanate, or 4-bromo-2-chlorophenyl isothiocyanate, or any isoform thereof. The functional group is selected from the group consisting of 1-naphthylamine, 2-aminoanthracene, 1-aminopyrene, 6-chrysenamine, 9-aminophenanthrene, 2-aminofluorene, 9-aminoacridine, 1,10-phenanthrolin-5-amine, 9H-carbazol-2-amine, or 3-amino-9-ethylcarbazole. The method includes flowing the tracer fluid into a first subterranean formation. The method includes recovering a sample from the first subterranean formation or a second subterranean formation connected to the first subterranean formation. The method includes analyzing the sample for a fluorescent signal.

This, and other aspects, can include one or more of the following features. The method can include identifying the functionalized fluorescent tracer in the sample using fluorescence, ultraviolet-visible (UV-Vis) spectroscopy, Fourier-transform infrared spectroscopy (FTIR), Raman spectroscopy, mass spectroscopy (MS), high performance liquid chromatography (HPLC), or liquid chromatography-mass spectroscopy (LC-MS), or any combination thereof. The sample can be a fluid sample. The sample can be a solid sample. The fluid can be a fracking fluid. The fluid can be a drilling mud. The method can include analyzing the sample for a barcode structure. The method can include identifying the isothiocyanate-containing compound of the functionalized fluorescent tracer based on the barcode structure.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example well.

FIG. 2 is a flow chart of an example method for making a functionalized fluorescent dye that can be used in the well of FIG. 1.

FIG. 3 is a flow chart of an example method for treating a well.

FIG. 4 is a molecular structure of an example functionalized fluorescent dye.

FIG. 5 is a molecular structure of an example functionalized fluorescent dye.

FIG. 6 is a molecular structure of an example functionalized fluorescent dye.

FIG. 7 is a molecular structure of an example functionalized fluorescent dye.

FIG. 8 is a molecular structure of an example functionalized fluorescent dye.

FIG. 9 is a molecular structure of an example functionalized fluorescent dye.

FIG. 10 is a molecular structure of an example functionalized fluorescent dye.

FIG. 11 is a molecular structure of an example functionalized fluorescent dye.

FIG. 12 is a molecular structure of an example functionalized fluorescent dye.

### DETAILED DESCRIPTION

This disclosure describes functionalized fluorescent tracers, methods of making the tracers, and methods of using the tracers. The functionalized fluorescent tracers can be used, for example, to track hydrocarbons in wells. A chemical method can be implemented to modify the structures of conventional fluorescent dye molecules by covalently bonding an aromatic compound to the dye molecule, which can increase the fluorescent dye's hydrophobicity. The resulting dye is oil-soluble while retaining its fluorescence. The aromatic compound can also serve as a molecular identifier.

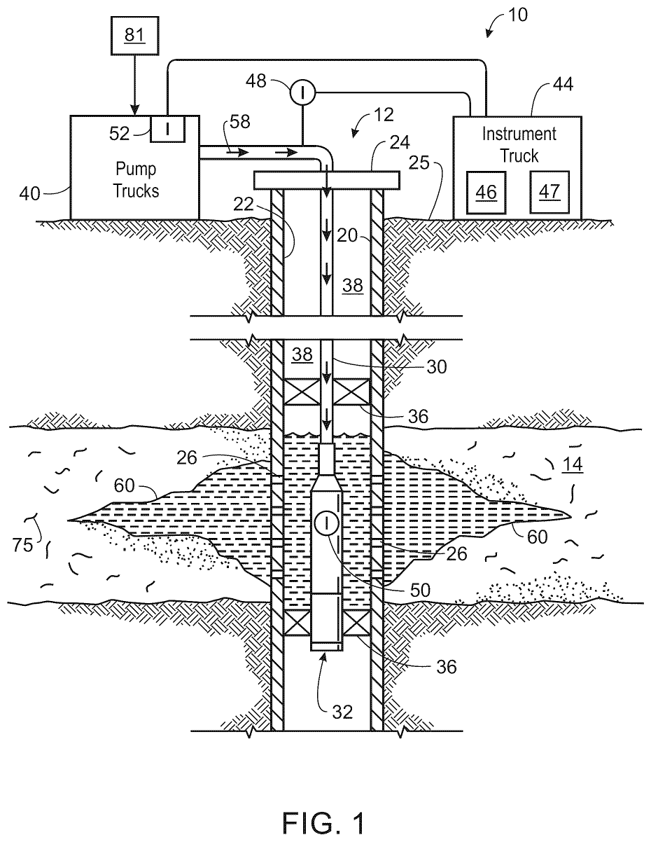

FIG. 1 depicts an example of a drilling operation 10 for a well 12. The well 12 can be in a wellbore 20 formed in a subterranean zone 14 of a geological formation in the Earth's crust. The well 12 enables access to the subterranean zone 14 to allow recovery (that is, production) of fluids to the surface and, in some implementations, additionally or alternatively allows fluids to be placed in the Earth. The subterranean zone 14 can include, for example, a formation, a portion of a formation, or multiple formations in a hydrocarbon-bearing reservoir from which recovery operations can be practiced to recover trapped hydrocarbons. Examples of unconventional reservoirs include tight-gas sands, gas and oil shales, coalbed methane, heavy oil and tar sands, gas-hydrate deposits, to name a few. In some implementations, the subterranean zone 14 includes an underground formation including natural fractures 60 in rock formations containing hydrocarbons (for example, oil, gas, or both). For example, the subterranean zone 14 can include a fractured shale. In some implementations, the well 12 can intersect other suitable types of formations, including reservoirs that are not naturally fractured.

The well 12 can include a casing 22 and well head 24. The wellbore 20 can be a vertical, horizontal, deviated, or multilateral bore. The casing 22 can be cemented or otherwise suitably secured in the wellbore 20. Perforations 26 can be formed in the casing 22 at the level of the subterranean zone 14 to allow oil, gas, and by-products to flow into the well 12 and be produced to the surface 25. Perforations 26 can be formed using shape charges, a perforating gun, or otherwise.

For a drilling treatment 10, a work string 30 can be disposed in the wellbore 20. The work string 30 can be coiled tubing, sectioned pipe, or other suitable tubing. A drilling tool or drill bit 32 can be coupled to an end of the work string 30. Packers 36 can seal an annulus 38 of the wellbore 20 uphole of and downhole of the subterranean zone 14. Packers 36 can be mechanical, fluid inflatable, or other suitable packers.

One or more pump trucks 40 can be coupled to the work string 30 at the surface 25. The pump trucks 40 pump drilling mud 58 down the work string 30 to lubricate and cool the drilling tool or drill bit 32, maintain hydrostatic pressure in the wellbore, and carry subterranean cuttings to the surface. The drilling mud 58 can include a fluid pad, proppants, flush fluid, or a combination of these components. The pump trucks 40 can include mobile vehicles, equipment such as skids, or other suitable structures.

One or more instrument trucks 44 can also be provided at the surface 25. The instrument truck 44 can include a drilling control system 46 and a drilling simulator 47. The drilling control system 46 monitors and controls the drilling treatment 10. The drilling control system 46 can control the pump trucks 40 and fluid valves to stop and start the drilling treatment 10. The drilling control system 46 communicates with surface and subsurface instruments to monitor and control the drilling treatment 10. In some implementations, the surface and subsurface instruments may comprise surface sensors 48, down-hole sensors 50, and pump controls 52.

Additives 81 can be mixed with drilling mud 58 or other drilling fluids and flowed through the reservoir. In some implementations, the additives 81 can include one or more tracers, for example, a fluorescent dye. Fluorescent dyes can be used as oil-soluble tracers. These dyes are inexpensive and easy to use. Examples of fluorescent dyes include fluorescein, eosin, Rhodamine, and Rhodamine-B. However, these organic dye-based tracers have some shortcomings as oil-soluble tracers. For example, the water-soluble tracers fluorescein, eosin, and Rhodamine can adsorb onto reservoir rock or partition with the oil phase. In oil, these tracers have poor solubility due to their high hydrophilicity, although the molecules may partially dissolve in the oil phase. In addition, the number of tracers is limited to the number of organic dye molecules available.

The tracers described herein overcome these shortcomings. These tracers can be generated using a synthetic method to chemically modify the molecular structure of a dye. For example, by covalently grafting functional groups onto the dye molecules, the various functional groups can create barcoded structural information, resulting in new compounds. In some embodiments, by introducing hydrophobic functional groups (for example, an aromatic functional group), the hydrophobicity of the resulting molecules can be enhanced, thus improving their solubility in an oil phase. By tailoring the molecules, the hydrophobicity of the molecule can be adjusted to a desired degree. Therefore, the partition of the molecule in an oil phase is controllable. This, in part, enables the potential application of these functionalized fluorescent dyes as partition tracers for oil reservoir applications. The structure-modified dyes reserve their fluorescence properties, although in some implementations the fluorescence features may also be modified by the introduction of functional groups.

These functionalized fluorescent dyes are described herein as barcoded or having barcode information. In this context, “barcode” refers to the fact that these functionalized dyes or tracers are uniquely identifiable two or more orthogonal analyses. As a first factor, the tracers can be identified by their fluorescence signal, for example, by the wavelength of the emission spectrum or simply by the presence of a fluorescent signal. As a second factor, the tracers can be identified by their mass or hydrophobicity. Accordingly, the unique combinations of the different fluorophores and the different functionalization groups results in a library of barcoded tracers.

Barcoded tracers have several advantages. For example, different combinations of different tracers can be used simultaneously or in parallel to provide information about drilling operations or subterranean formations. For example, two or more uniquely identifiable tracers can be injected at two or more different drilling sites and can yield information about inter well connectivity. In another example, uniquely identifiable tracers can be injected at the same drilling site at different times, can yield temporal information about transit time, depth, or length of subterranean fractures or formations.

Further, the two-factor nature of the barcode tracers allows for an advantageous two-factor analysis. The first factor, the fluorescence signal, can be detected in an initial, rapid analysis. Accordingly, samples recovered from a drilling operation or subterranean formation can be quickly and qualitative analyzed for the presence of a fluorescence signal, i.e., a ‘yes/no’ analysis. In some implementations, this first analysis can be done on-site, and samples exhibiting a fluorescence signal can be allocated for further processing. Next, the samples exhibiting a fluorescence signal can be subsequently separated and analyzed by mass or chromatographic methods, for example by high performance liquid chromatography (HPLC), mass spectrometry (MS), or liquid chromatography-mass spectrometry (LC-MS) analysis.

A chemical method to modify the structures of conventional dye molecules by introducing molecular barcode information and by tailoring the hydrophobicity of the dye molecules is described herein. The resulting compounds expand the number of dyes available for tracer applications as oil tracers or partition tracers.

The new dye molecules include substituted thioureas represented by the general structure of the reaction product shown in Equation 1. As shown in Equation 1, the new dye molecules can be synthesized by reacting an isothiocyanate (R_{I}-NCS) with a primary amine (R_{II}-NH₂). The R_{I} group is a hydrophobic group which can be aliphatic or aromatic. In the general structure, R_{I} can be selected from the group that includes hydrogen, alkoxy, haloalkoxy (including Cl, Br, or I), aryl, or heteroaryl (including N, NH, O, or S). The R_{I} group confers a molecular fingerprint or barcode structure into the new dye molecules. The R_{II} group is a hydrophobic aromatic group that is fluorescent. The R_{II} group can be detectable by optical methods, for example, fluorescence imaging or molecular spectroscopy (absorbance or fluorescence). The substituted thioureas (new dye molecules) are detectable by spectroscopy methods, for example, UV Visible spectroscopy (UV-Vis), fluorescence, Fourier-transform infrared spectroscopy (FTIR), Raman spectroscopy, mass spectroscopy, or chromatography (such as HPLC or LC-MS).

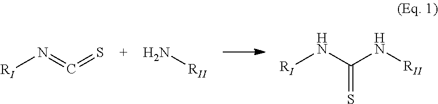

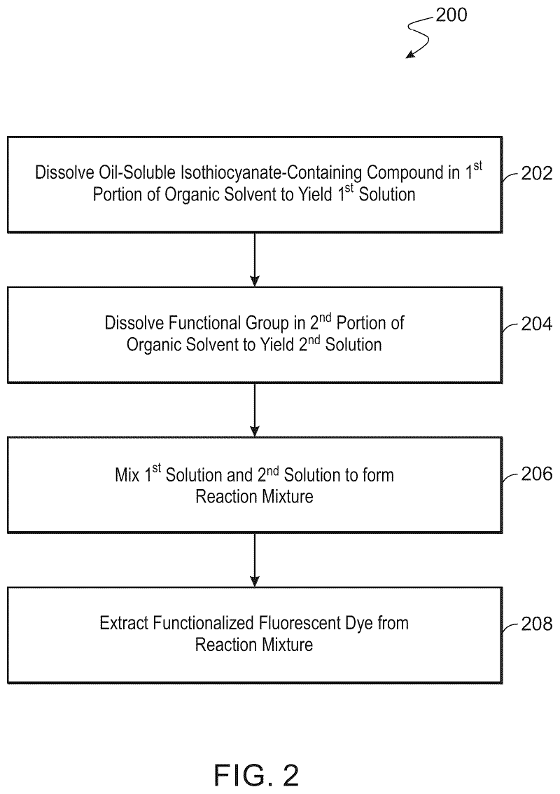

FIG. 2 is a flow chart of an example method 200 of making a functionalized fluorescent dye. The functionalized fluorescent dye can be used, for example, to trace an oil phase in a subterranean formation. Method 200 can be implemented to form a substituted thiourea (reaction product of Equation 1). The reactions were performed at room temperature in an organic solvent. At block 202, an oil-soluble isothiocyanate-containing compound is dissolved in a first portion of the organic solvent to yield a first solution. The oil-soluble isothiocyanate-containing compound can be considered a barcode that can be detected and used to identify the functionalized fluorescent dye that is to be formed and used as an oil tracer. At block 204, an aromatic/heterocyclic compound including a primary amino group is dissolved in a second portion of the organic solvent to yield a second solution. The aromatic/heterocyclic compound at block 204 is a primary amine. The aromatic/heterocyclic compound at block 204 is a fluorophore. The organic solvent at blocks 202 and 204 is any organic solvent in which both the oil-soluble isothiocyanate-containing compound and the aromatic/heterocyclic compound are soluble. For example, the organic solvent at blocks 202 and 204 is methanol, ethanol, propanol, isopropanol, chloroform, dichloromethane, acetone, cyclohexane, hexane, benzene, or toluene. The first solution and the second solution each contain the same molecular molar concentration of the oil-soluble isothiocyanate-containing compound and the aromatic/heterocyclic compound, respectively. At block 206, the first solution and the second solution are mixed to form a reaction mixture. In some implementations, the first solution and the second solution are mixed in equal volumes at block 206 and stirred vigorously. In some implementations, the reaction between the oil-soluble isothiocyanate-containing compound and the aromatic/heterocyclic compound is allowed to continue while stirring for at least 12 hours, at least 14 hours, at least 16 hours, at least 18 hours, at least 20 hours, at least 22 hours, or at least 24 hours at block 206. At block 208, a functionalized fluorescent dye is extracted from the reaction mixture. The functionalized fluorescent dye extracted at block 208 is a reaction product of the oil-soluble isothiocyanate-containing compound and the aromatic/heterocyclic compound including the primary amino group. The functionalized fluorescent dye extracted at block 208 is the new dye molecule that can be used as an oil tracer. In some implementations, extracting the functionalized fluorescent dye from the reaction mixture at block 208 includes evaporating the organic solvent by nitrogen bubbling, heating, rotary evaporation, or a combination of these. The obtained solid powder (functionalized fluorescent dye) can be re-dispersed into a different organic solvent, such as crude oil, diesel, mineral oil, food oil, methanol, ethanol, propanol, isopropanol, butanol, pentanol, hexanol, heptanol, octenol, acetone, ethyl acetate, acetonitrile, chloroform, hexane, heptane, cyclohexane, benzene, toluene, tetrahydrofuran, or any combination of these.

Table 1 illustrates different oil-soluble isothiocyanate-containing compounds. The compounds shown in Table 1 include different alkyl functional groups. The oil-soluble isothiocyanate-containing compound (used in block 202 of method 200) can be selected from any of the compounds shown in Table 1. R_{I}-NCS for forming a substituted thioruea (reaction product of Equation 1) can be selected from any of the compounds shown in Table 1.

TABLE 1
Isothiocyanate-containing Compounds with Alkyl Functional Groups

| Compound | Molecular Structure/Weight (Daltons) | CAS number |
|---|---|---|
| Methyl isothiocyanate | 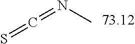 | 556-61-6 |
| Ethyl isothiocyanate | 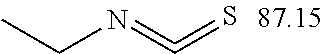 | 542-85-8 |
| Propyl isothiocyanate | 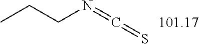 | 628-30-8 |
| Isopropyl isothiocyanate | 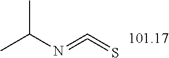 | 2253-73-8 |
| Butyl isothiocyanate | 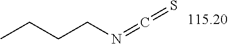 | 592-82-5 |
| Tert-butyl isothiocyanate | 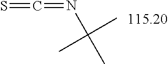 | 590-42-1 |
| Hexyl isothiocyanate | 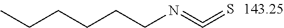 | 4404-45-9 |
| Octyl isothiocyanate | 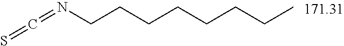 | 4430-45-9 |
| Decyl isothiocyanate | 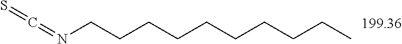 | 24540-94-1_{[PH1]} |
| Dodecyl isothiocyanate | 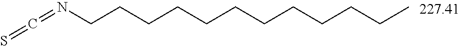 | 1072-32-8_{[PH2]} |
| Tetradecyl isothiocyanate | 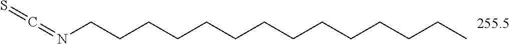 [SMILES: CCCCCCCCCCCCCCN=C=S] | 3224-48-4_{[PH3]} |
| Hexadecyl isothiocyanate | 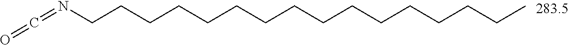 [SMILES: CCCCCCCCCCCCCCCCN=C=O] | 4426-87-3_{[PH4]} |
| Octadecyl isothiocyanate | 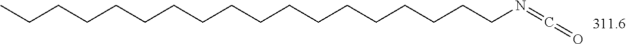 [SMILES: CCCCCCCCCCCCCCCCCCN=C=O] | 2877-26-1_{[PH5]} |

Table 2 illustrates different oil-soluble isothiocyanate-containing compounds. The compounds shown in Table 2 include different cyclic groups. The cyclic groups can be aromatic or non-aromatic. The oil-soluble isothiocyanate-containing compound (used in block 202 of method 200) can be selected from any of the compounds shown in Table 2. R_{I}-NCS for forming a substituted thioruea (reaction product of Equation 1) can be selected from any of the compounds shown in Table 2.

TABLE 2
Isothiocyanate-containing Compounds with Cyclic Groups

| | | CAS |
|---|---|---|
| Compound | Molecular Structure/Weight (Daltons) | number |
| Phenyl isothiocyanate | 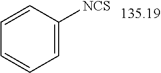 | 103- 72-0 |
| Benzyl isothiocyanate | 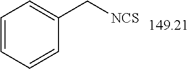 | 622- 78-6 |
| Phenylethyl isothiocyanate | 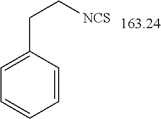 | 2257- 09-2 |
| Cyclohexyl isothiocyanate | 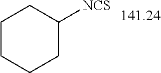 | 1122- 82-3 |
| Cyclohexylmethyl isothiocyanate | 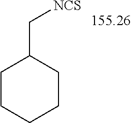 | 52395- 66-1 |
| 2-piperidinoethyl isothiocyanate | 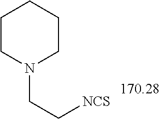 | 32813- 24-4 |
| p-Tolyl isothiocyanate | 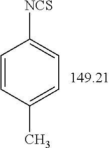 | 622- 59-3 |
| 2,6-dimethylphenyl isothiocyanate | 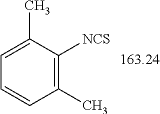 | 19241- 16-8 |
| 4-ethylphenyl isothiocyanate | 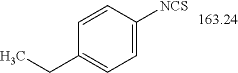 | 18856- 63-8 |
| 4-methoxyphenyl isothiocyanate | 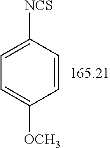 | 2284- 20-0 |
| 2,4- dimethoxyphenyl isothiocyanate | 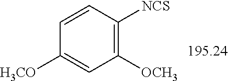 | 33904- 03-9 |
| 4-chlorophenyl isothiocyanate | 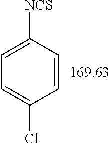 | 2131- 55-7 |
| 2,6-dichlorophenyl isothiocyanate | 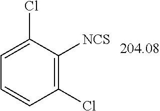 | 6590- 95-0 |
| 2,4,5- trichlorophenyl isothiocyanate | 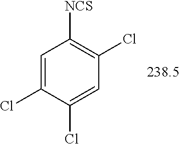 | 23165- 46-0 |
| 3-bromophenyl isothiocyanate | 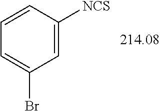 | 2131- 59-1 |
| 2,5-dibromophenyl isothiocyanate | 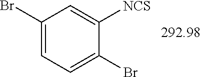 | 98041- 67-9 |
| 2,4,6- tribromophenyl isothiocyanate | 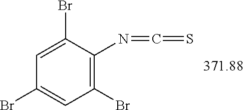 [SMILES: S=C=Nc1c(Br)cc(Br)cc1Br] | 22134- 11-8 |
| 3-fluorophenyl isothiocyanate | 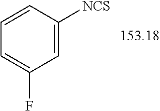 | 404- 72-8 |
| 2,6-difluorophenyl isothiocyanate | 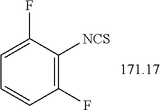 | 207974- 17-2 |
| 2,4,6- trifluorophenyl isothiocyanate | 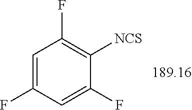 | 206761- 91-3 |
| 4-(Trifluoro- methyl) phenyl isothiocyanate | 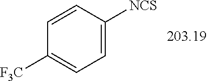 | 1645- 65-4 |
| 3,5-Bis (trifluoromethyl) phenyl isothiocyanate | 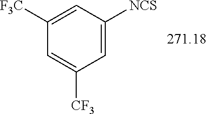 | 23165- 29-9 |
| 2-Chloro-5- (trifluoromethyl) phenyl isothiocyanate | 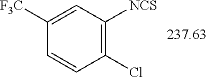 | 23165- 49-3 |
| 4-Bromo-2- (trifluoromethyl) phenyl isothiocyanate | 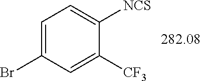 | 206559- 46-8 |
| 4-Fluoro-3- (trifluoromethyl) phenyl isothiocyanate | 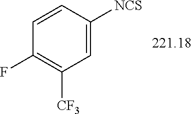 | 302912- 43-2 |
| 3-Chloro-4- fluorophenyl isothiocyanate | 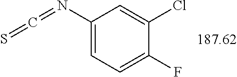 [SMILES: Fc1ccc(N=C=S)cc1Cl] | 137724- 66-4 |
| 2-Bromo-4- fluorophenyl isothiocyanate | 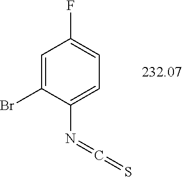 [SMILES: Fc1ccc(N=C=S)c(Br)c1] | 183995- 72-4 |
| 4-Bromo-2- chlorophenyl isothiocyanate | 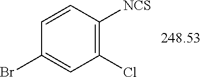 | 98041- 69-1 |

Table 3 illustrates different aromatic amine-containing functional groups that can be used to functionalize an isothiocyanate-containing compound. The compounds shown in Table 3 are aromatic or heterocyclic compounds with primary amino groups. The aromatic/heterocyclic compound including the primary amino group (used in block 204 of method 200) can be selected from any of the compounds shown in Table 3. R_{II}-NH₂ for forming a substituted thioruea (reaction product of Equation 1) can be selected from any of the compounds shown in Table 3. The compounds have different molecular weights and provide both barcode information and the ability to tailor the hydrophobicity and miscibility with oils of the resulting compound, based on, for example, the number of cyclic rings. Accordingly, isothiocyanate-containing compounds functionalized with the compounds listed in Table 3 can have variable partitioning in oil phases.

TABLE 3
Aromatic Compounds with Primary Amino Groups

| Compound | Molecular Structure/Weight (Daltons) | CAS number |
|---|---|---|
| 1-naphthylamine | 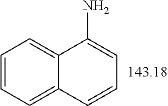 [SMILES: Nc1cccc2ccccc12] | 134-32-7 |
| 2-aminoanthracene | 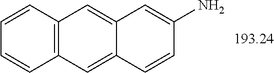 [SMILES: Nc1ccc2cc3ccccc3cc2c1] | 613-13-8 |
| 1-aminopyrene | 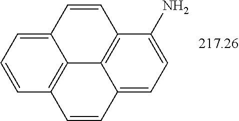 [SMILES: Nc1ccc2ccc3cccc4ccc1c2c34] | 1606-67-3 |
| 6-chrysenamine | 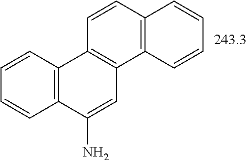 [SMILES: Nc1cc2c3ccccc3ccc2c2ccccc12] | 2642-98-0 |
| 9-aminophenanthrene | 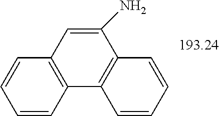 [SMILES: Nc1cc2ccccc2c2ccccc12] | 947-73-9 |
| 2-aminofluorene | 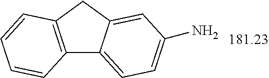 [SMILES: Nc1ccc2c(c1)Cc1ccccc1-2] | 153-78-6 |
| 9-aminoacridine | 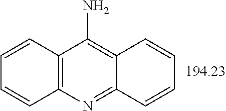 [SMILES: Nc1c2ccccc2nc2ccccc12] | 90-45-9 |
| 1,10-phenanthrolin-5-amine | 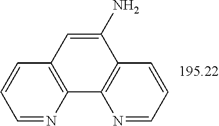 [SMILES: Nc1cc2cccnc2c2ncccc12] | 54258-41-2 |
| 9H-carbazol-2-amine (hydrochloride) | 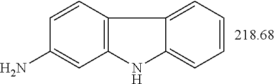 [SMILES: Nc1ccc2c(c1)[nH]c1ccccc12] | 63716-35-8 |
| 3-amino-9-ethylcarbazole | 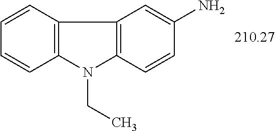 [SMILES: CCn1c2ccccc2c2cc(N)ccc21] | 132-32-1 |

The dyes described herein can be used as tracers in subterranean applications. For example. multistage hydraulic fracturing along a horizontal well is key to effectively recover hydrocarbons from tight reservoirs. Improving the hydrocarbon recovery requires detailed production information of each hydraulic fracture. Water-soluble chemical tracers are often used to calculate the production profile from multistage fracturing through a tracer flow back test, whereas oil-soluble tracers are used as a direct indicator to estimate the oil production contribution in individual fractures stages, for example, diagnosis of multi-zone oil flow efficiency, confirming zonal oil flow, or qualifying flow assurance. Oil-soluble tracers can also be embedded in the porous media and absorbed on the surfaces of solid carriers, which allows the tracers to be released from their carriers when oil passes through and has negligible partitioning into the water or gas phase.

With the barcoded oil-soluble tracers described herein, qualitative analysis by fluorescence spectroscopy or imaging can be used for early screening if the tracer is in the oil flow from each stage, while detailed molecular barcode information can be revealed by HPLC or LC-MS analysis to identify each tracers from different locations. Further, these synthesized barcoded oil-soluble compounds can also be added to mud formulations in drilling fluids as mud tracers for mud logging applications.

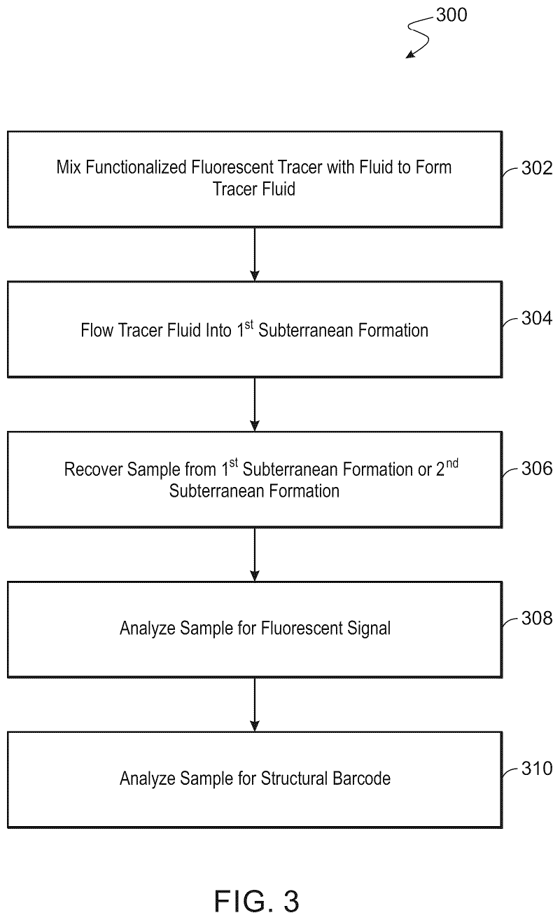

FIG. 3 is a flow chart of an example method 300 of tracing fluid flow in a subterranean formation. At 302, a functionalized fluorescent tracer (such as the functionalized fluorescent tracer formed by method 200) and a fluid are mixed to form a tracer fluid. At 304, the tracer fluid is flowed into a first subterranean formation. At 306, a sample is recovered from the first subterranean formation or a second subterranean formation connected to the first subterranean formation. At 308, the sample is analyzed for a fluorescent signal. At block 310, the sample is analyzed for a barcode structure. Once the barcode structure is determined based on analysis of the sample at block 310, the specific tracer that was used (for example, at blocks 302 and 304) can be identified based on the determined barcode structure.

### Example 1

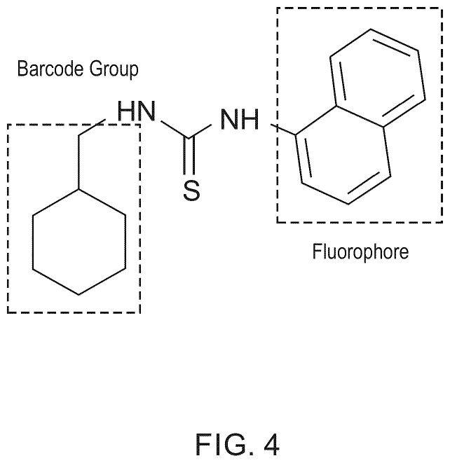

1.43 grams (g) of 1-naphthylamine (Sigma-Aldrich, >99%, MW=143.18) was dissolved in 50 milliliters (mL) of chloroform. 1.55 g of cyclohexylmethyl isothiocyanate (TCI, >98%, MW=155.26) was separately dissolved in 50 mL of chloroform. The two solutions were mixed in a round bottom flask and reacted for more than 24 hours under vigorous stirring by a magnetic stirrer. Assuming all molecules were conjugated to non-symmetrical aliphatic thioureas, the reaction product was an N-(1-naphthylene)-N′-cyclohexylmethylthiourea compound with a nominal concentration of 0.1 molar (M) in chloroform solution. Upon completion of the reaction, the chloroform was evaporated by nitrogen blowdown, and the solid powder sample was collected for further re-dissolving in a different organic solvent. The molecular structure of the functionalized fluorescent dye is shown in FIG. 4.

### Example 2

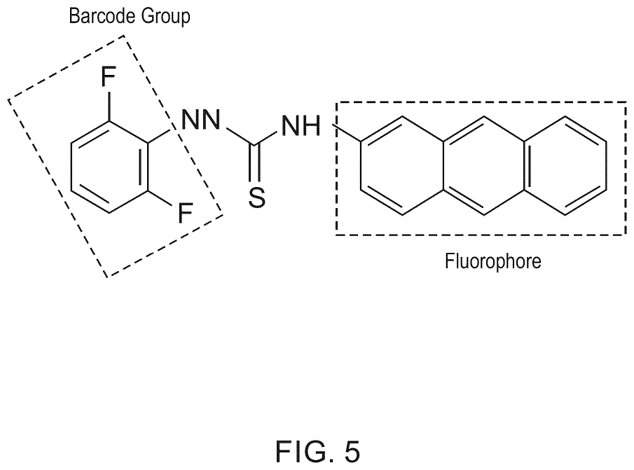

1.93 g of 2-aminoanthracene (Alfa Aesar, 94%, MW=193.24) was dissolved in 50 mL of acetone. 1.71 g of 2,6-difluorophenyl isothiocyanate (Alfa Aesar, 97%, MW=171.17) was separately dissolved in 50 mL of acetone. The two solutions were mixed in a round bottom flask and reacted for more than 24 hours under vigorous stirring by a magnetic stirrer. Assuming all molecules were conjugated to non-symmetrical aromatic thioureas, the reaction product was an N-(2-anthracene)-N′-(2,6-difluorophenyl)thiourea compound with a nominal concentration of 0.1 M in acetone solution. Upon completion of the reaction, the acetone was evaporated by nitrogen blowdown, and the solid powder sample was collected for further re-dissolving in a different organic solvent. The molecular structure of the functionalized fluorescent dye is shown in FIG. 5.

### Example 3

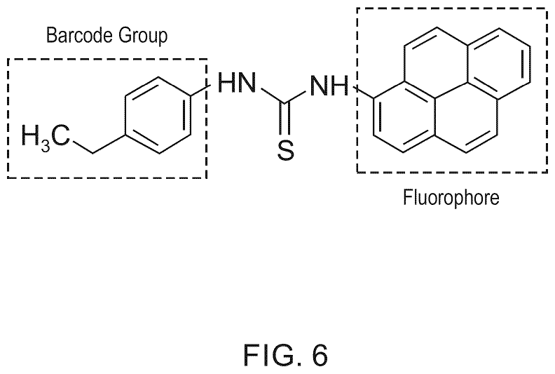

2.17 g of 1-aminopyrene (TCI, >98%, MW=217.26) was dissolved in 50 mL of acetone. 1.63 g of 4-ethylphenyl isothiocyanate (Alfa Aesar, 97%, MW=163.24) was separately dissolved in 50 mL of acetone. The two solutions were mixed in a round bottom flask and reacted for more than 24 hours under vigorous stirring by a magnetic stirrer. Assuming all molecules were conjugated to non-symmetrical aromatic thioureas, the reaction product was an N-(1-pyrene)-N′-(4-ethylbenzyl)thiourea compound with a nominal concentration of 0.1 M in acetone solution. Upon completion of the reaction, the acetone was evaporated by nitrogen blowdown, and the solid powder sample was collected for further re-dissolving in a different organic solvent. The molecular structure of the functionalized fluorescent dye is shown in FIG. 6.

### Example 4

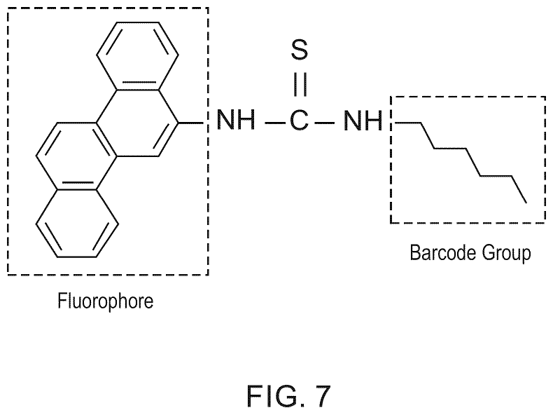

2.43 g of 6-chrysenamine (Sigma-Aldrich, 95%, MW=243.3) was dissolved in 50 mL of acetone. 1.43 g of hexyl isothiocyanate (Alfa Aesar, 97%, MW=143.25) was separately dissolved in 50 mL of acetone. The two solutions were mixed in a round bottom flask and reacted for more than 24 hours under vigorous stirring by a magnetic stirrer. Assuming all molecules were conjugated to aromatic-aliphatic thioureas, the reaction product was an N-(6-chrysene)-N′-hexylthiourea compound with a nominal concentration of 0.1 M in acetone solution. Upon completion of the reaction, the acetone was evaporated by nitrogen blowdown, and the solid powder sample was collected for further re-dissolving in a different organic solvent. The molecular structure of the functionalized fluorescent dye is shown in FIG. 7.

### Example 5

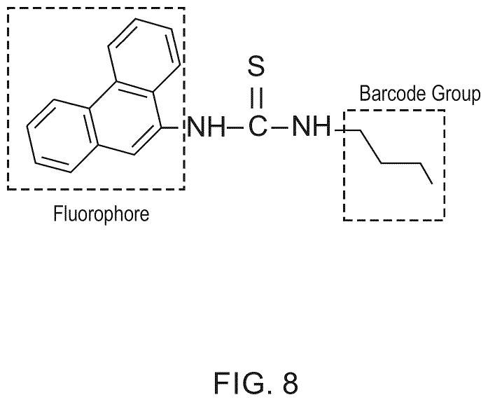

1.93 g of 9-aminophenanthrene (Alfa Aesar, 96%, MW=193.24) was dissolved in 50 mL of chloroform. 1.15 g of butyl isothiocyanate (Matrix Scientific, 99%, MW=115.2) was separately dissolved in 50 mL of chloroform. The two solutions were mixed in a round bottom flask and reacted for more than 24 hours under vigorous stirring by a magnetic stirrer. Assuming all molecules were conjugated to aromatic-aliphatic thioureas, the reaction product was an N-(9-phenanthrene)-N′-butylthiourea compound with a nominal concentration of 0.1 M in chloroform solution. Upon completion of the reaction, the chloroform was evaporated by nitrogen blowdown, and the solid powder sample was collected for further re-dissolving in a different organic solvent. The molecular structure of the functionalized fluorescent dye is shown in FIG. 8.

### Example 6

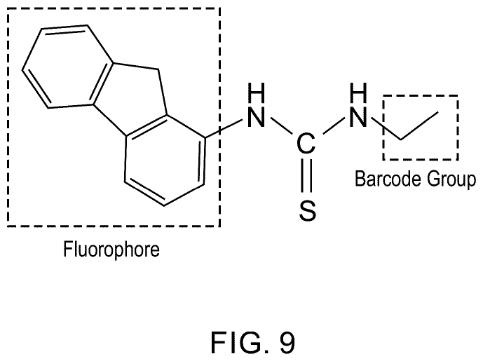

2.17 g of 1-aminofluorene (TCI, >98%, MW=181.23) was dissolved in 50 mL of ethanol. 0.87 g of ethyl isothiocyanate (Alfa Aesar, 97%, MW=87.15) was separately dissolved in 50 mL of ethanol. The two solutions were mixed in a round bottom flask and reacted for more than 24 hours under vigorous stirring by a magnetic stirrer. Assuming all molecules were conjugated to aromatic-aliphatic thioureas, the reaction product was an N-(1-fluorene)-N′-ethylthiourea compound with a nominal concentration of 0.1 M in ethanol solution. Upon completion of the reaction, the ethanol was evaporated by nitrogen blowdown, and the solid powder sample was collected for further re-dissolving in a different organic solvent. The molecular structure of the functionalized fluorescent dye is shown in FIG. 9.

### Example 7

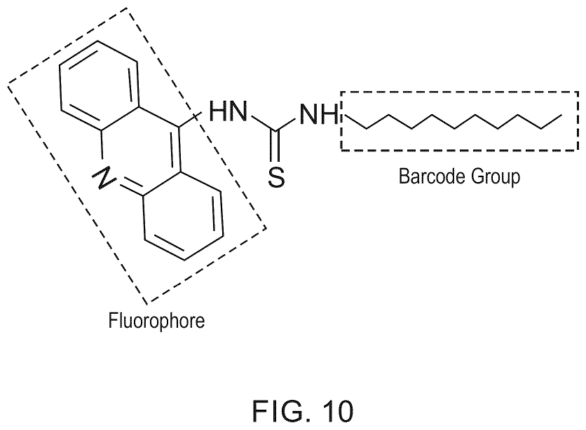

1.94 g of 9-aminoacridine (TCI, >97%, MW=194.24) was dissolved in 50 mL of ethanol. 1.99 g of decyl isothiocyanate (Matrix Scientific, 99%, MW=199.36) was separately dissolved in 50 mL of ethanol. The two solutions were mixed in a round bottom flask and reacted for more than 24 hours under vigorous stirring by a magnetic stirrer. Assuming all molecules were conjugated to aromatic-aliphatic thioureas, the reaction product was an N-(9-acridine)-N′-decylthiourea compound with a nominal concentration of 0.1 M in ethanol solution. Upon completion of the reaction, the ethanol was evaporated by nitrogen blowdown, and the solid powder sample was collected for further re-dissolving in a different organic solvent. The molecular structure of the functionalized fluorescent dye is shown in FIG. 10.

### Example 8

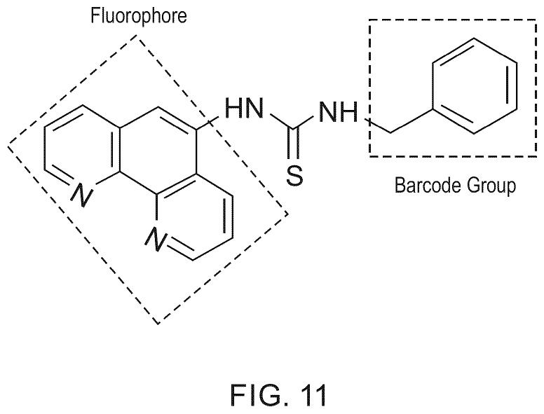

1.95 g of 1,10-phenanthrolin-5-amine (AmBeed, 98%, MW=195.22) was dissolved in 50 mL of ethanol. 1.49 g of benzyl isothiocyanate (Acros Organics, 98%, MW=149.21) was separately dissolved in 50 mL of ethanol. The two solutions were mixed in a round bottom flask and reacted for more than 24 hours under vigorous stirring by a magnetic stirrer. Assuming all molecules were conjugated to non-symmetrical aromatic thioureas, the reaction product was an N-(5-(1,10-phenanthroline))-N′-benzylthiourea compound with a nominal concentration of 0.1 M in ethanol solution. Upon completion of the reaction, the ethanol was evaporated by nitrogen blowdown, and the solid powder sample was collected for further re-dissolving in a different organic solvent. The molecular structure of the functionalized fluorescent dye is shown in FIG. 11.

### Example 9

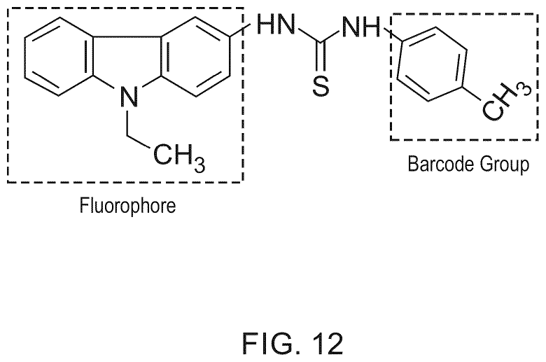

2.10 g of 3-amino-9-ethylcarbazole (Acros Organics, 90% Tech, MW=210.27) was dissolved in 50 mL of chloroform. 1.49 g of p-tolyl isothiocyanate (Sigma-Aldrich, 97%, MW=149.21) was separately dissolved in 50 mL of chloroform. The two solutions were mixed in a round bottom flask and reacted for more than 24 hours under vigorous stirring by a magnetic stirrer. Assuming all molecules were conjugated to non-symmetrical aromatic thioureas, the reaction product was an N-(3-(9-ethylcarbazole))-N′-tolylthiourea compound with a nominal concentration of 0.1 M in chloroform solution. Upon completion of the reaction, the chloroform was evaporated by nitrogen blowdown, and the solid powder sample was collected for further re-dissolving in a different organic solvent. The molecular structure of the functionalized fluorescent dye is shown in FIG. 12.

Examples 1, 2, 3, 4, 5, 6, 7, 8, and 9 provide example procedures for making a functionalized fluorescent dye. With similar procedures, any one of the isothiocyanate-containing compounds shown in Table 1 can be combined with any one of the aromatic compounds with primary amino groups shown in Table 3. With similar procedures, any one of the isothiocyanate-containing compounds shown in Table 2 can be combined with any one of the aromatic compounds with primary amino groups shown in Table 3. The following two paragraphs include example combinations of isothiocyanate-containing compounds and aromatic compounds with primary amino groups that can be combined to make a functionalized fluorescent dye.

Methyl isothiocyanate and 1-naphthylamine can be combined to make a functionalized fluorescent dye. Methyl isothiocyanate and 2-aminoanthracene can be combined to make a functionalized fluorescent dye. Methyl isothiocyanate and 1-aminopyrene can be combined to make a functionalized fluorescent dye. Methyl isothiocyanate and 6-chrysenamine can be combined to make a functionalized fluorescent dye. Methyl isothiocyanate and 9-aminophenanthrene can be combined to make a functionalized fluorescent dye. Methyl isothiocyanate and 2-aminofluorene can be combined to make a functionalized fluorescent dye. Methyl isothiocyanate and 9-aminoacridine can be combined to make a functionalized fluorescent dye. Methyl isothiocyanate and 1,10-phenanthrolin-5-amine can be combined to make a functionalized fluorescent dye. Methyl isothiocyanate and 9H-carbazol-2-amine (hydrochloride) can be combined to make a functionalized fluorescent dye. Methyl isothiocyanate and 3-amino-9-ethylcarbazole can be combined to make a functionalized fluorescent dye. Ethyl isothiocyanate and 1-naphthylamine can be combined to make a functionalized fluorescent dye. Ethyl isothiocyanate and 2-aminoanthracene can be combined to make a functionalized fluorescent dye. Ethyl isothiocyanate and 1-aminopyrene can be combined to make a functionalized fluorescent dye. Ethyl isothiocyanate and 6-chrysenamine can be combined to make a functionalized fluorescent dye. Ethyl isothiocyanate and 9-aminophenanthrene can be combined to make a functionalized fluorescent dye. Ethyl isothiocyanate and 2-aminofluorene can be combined to make a functionalized fluorescent dye. Ethyl isothiocyanate and 9-aminoacridine can be combined to make a functionalized fluorescent dye. Ethyl isothiocyanate and 1,10-phenanthrolin-5-amine can be combined to make a functionalized fluorescent dye. Ethyl isothiocyanate and 9H-carbazol-2-amine (hydrochloride) can be combined to make a functionalized fluorescent dye. Ethyl isothiocyanate and 3-amino-9-ethylcarbazole can be combined to make a functionalized fluorescent dye. Propyl isothiocyanate and 1-naphthylamine can be combined to make a functionalized fluorescent dye. Propyl isothiocyanate and 2-aminoanthracene can be combined to make a functionalized fluorescent dye. Propyl isothiocyanate and 1-aminopyrene can be combined to make a functionalized fluorescent dye. Propyl isothiocyanate and 6-chrysenamine can be combined to make a functionalized fluorescent dye. Propyl isothiocyanate and 9-aminophenanthrene can be combined to make a functionalized fluorescent dye. Propyl isothiocyanate and 2-aminofluorene can be combined to make a functionalized fluorescent dye. Propyl isothiocyanate and 9-aminoacridine can be combined to make a functionalized fluorescent dye. Propyl isothiocyanate and 1,10-phenanthrolin-5-amine can be combined to make a functionalized fluorescent dye. Propyl isothiocyanate and 9H-carbazol-2-amine (hydrochloride) can be combined to make a functionalized fluorescent dye. Propyl isothiocyanate and 3-amino-9-ethylcarbazole can be combined to make a functionalized fluorescent dye. Isopropyl isothiocyanate and 1-naphthylamine can be combined to make a functionalized fluorescent dye. Isopropyl isothiocyanate and 2-aminoanthracene can be combined to make a functionalized fluorescent dye. Isopropyl isothiocyanate and 1-aminopyrene can be combined to make a functionalized fluorescent dye. Isopropyl isothiocyanate and 6-chrysenamine can be combined to make a functionalized fluorescent dye. Isopropyl isothiocyanate and 9-aminophenanthrene can be combined to make a functionalized fluorescent dye. Isopropyl isothiocyanate and 2-aminofluorene can be combined to make a functionalized fluorescent dye. Isopropyl isothiocyanate and 9-aminoacridine can be combined to make a functionalized fluorescent dye. Isopropyl isothiocyanate and 1,10-phenanthrolin-5-amine can be combined to make a functionalized fluorescent dye. Isopropyl isothiocyanate and 9H-carbazol-2-amine (hydrochloride) can be combined to make a functionalized fluorescent dye. Isopropyl isothiocyanate and 3-amino-9-ethylcarbazole can be combined to make a functionalized fluorescent dye. Butyl isothiocyanate and 1-naphthylamine can be combined to make a functionalized fluorescent dye. Butyl isothiocyanate and 2-aminoanthracene can be combined to make a functionalized fluorescent dye. Butyl isothiocyanate and 1-aminopyrene can be combined to make a functionalized fluorescent dye. Butyl isothiocyanate and 6-chrysenamine can be combined to make a functionalized fluorescent dye. Butyl isothiocyanate and 9-aminophenanthrene can be combined to make a functionalized fluorescent dye. Butyl isothiocyanate and 2-aminofluorene can be combined to make a functionalized fluorescent dye. Butyl isothiocyanate and 9-aminoacridine can be combined to make a functionalized fluorescent dye. Butyl isothiocyanate and 1,10-phenanthrolin-5-amine can be combined to make a functionalized fluorescent dye. Butyl isothiocyanate and 9H-carbazol-2-amine (hydrochloride) can be combined to make a functionalized fluorescent dye. Butyl isothiocyanate and 3-amino-9-ethylcarbazole can be combined to make a functionalized fluorescent dye. Tert-butyl isothiocyanate and 1-naphthylamine can be combined to make a functionalized fluorescent dye. Tert-butyl isothiocyanate and 2-aminoanthracene can be combined to make a functionalized fluorescent dye. Tert-butyl isothiocyanate and 1-aminopyrene can be combined to make a functionalized fluorescent dye. Tert-butyl isothiocyanate and 6-chrysenamine can be combined to make a functionalized fluorescent dye. Tert-butyl isothiocyanate and 9-aminophenanthrene can be combined to make a functionalized fluorescent dye. Tert-butyl isothiocyanate and 2-aminofluorene can be combined to make a functionalized fluorescent dye. Tert-butyl isothiocyanate and 9-aminoacridine can be combined to make a functionalized fluorescent dye. Tert-butyl isothiocyanate and 1,10-phenanthrolin-5-amine can be combined to make a functionalized fluorescent dye. Tert-butyl isothiocyanate and 9H-carbazol-2-amine (hydrochloride) can be combined to make a functionalized fluorescent dye. Tert-butyl isothiocyanate and 3-amino-9-ethylcarbazole can be combined to make a functionalized fluorescent dye. Hexyl isothiocyanate and 1-naphthylamine can be combined to make a functionalized fluorescent dye. Hexyl isothiocyanate and 2-aminoanthracene can be combined to make a functionalized fluorescent dye. Hexyl isothiocyanate and 1-aminopyrene can be combined to make a functionalized fluorescent dye. Hexyl isothiocyanate and 6-chrysenamine can be combined to make a functionalized fluorescent dye. Hexyl isothiocyanate and 9-aminophenanthrene can be combined to make a functionalized fluorescent dye. Hexyl isothiocyanate and 2-aminofluorene can be combined to make a functionalized fluorescent dye. Hexyl isothiocyanate and 9-aminoacridine can be combined to make a functionalized fluorescent dye. Hexyl isothiocyanate and 1,10-phenanthrolin-5-amine can be combined to make a functionalized fluorescent dye. Hexyl isothiocyanate and 9H-carbazol-2-amine (hydrochloride) can be combined to make a functionalized fluorescent dye. Hexyl isothiocyanate and 3-amino-9-ethylcarbazole can be combined to make a functionalized fluorescent dye. Octyl isothiocyanate and 1-naphthylamine can be combined to make a functionalized fluorescent dye. Octyl isothiocyanate and 2-aminoanthracene can be combined to make a functionalized fluorescent dye. Octyl isothiocyanate and 1-aminopyrene can be combined to make a functionalized fluorescent dye. Octyl isothiocyanate and 6-chrysenamine can be combined to make a functionalized fluorescent dye. Octyl isothiocyanate and 9-aminophenanthrene can be combined to make a functionalized fluorescent dye. Octyl isothiocyanate and 2-aminofluorene can be combined to make a functionalized fluorescent dye. Octyl isothiocyanate and 9-aminoacridine can be combined to make a functionalized fluorescent dye. Octyl isothiocyanate and 1,10-phenanthrolin-5-amine can be combined to make a functionalized fluorescent dye. Octyl isothiocyanate and 9H-carbazol-2-amine (hydrochloride) can be combined to make a functionalized fluorescent dye. Octyl isothiocyanate and 3-amino-9-ethylcarbazole can be combined to make a functionalized fluorescent dye. Decyl isothiocyanate and 1-naphthylamine can be combined to make a functionalized fluorescent dye. Decyl isothiocyanate and 2-aminoanthracene can be combined to make a functionalized fluorescent dye. Decyl isothiocyanate and 1-aminopyrene can be combined to make a functionalized fluorescent dye. Decyl isothiocyanate and 6-chrysenamine can be combined to make a functionalized fluorescent dye. Decyl isothiocyanate and 9-aminophenanthrene can be combined to make a functionalized fluorescent dye. Decyl isothiocyanate and 2-aminofluorene can be combined to make a functionalized fluorescent dye. Decyl isothiocyanate and 9-aminoacridine can be combined to make a functionalized fluorescent dye. Decyl isothiocyanate and 1,10-phenanthrolin-5-amine can be combined to make a functionalized fluorescent dye. Decyl isothiocyanate and 9H-carbazol-2-amine (hydrochloride) can be combined to make a functionalized fluorescent dye. Decyl isothiocyanate and 3-amino-9-ethylcarbazole can be combined to make a functionalized fluorescent dye. Dodecyl isothiocyanate and 1-naphthylamine can be combined to make a functionalized fluorescent dye. Dodecyl isothiocyanate and 2-aminoanthracene can be combined to make a functionalized fluorescent dye. Dodecyl isothiocyanate and 1-aminopyrene can be combined to make a functionalized fluorescent dye. Dodecyl isothiocyanate and 6-chrysenamine can be combined to make a functionalized fluorescent dye. Dodecyl isothiocyanate and 9-aminophenanthrene can be combined to make a functionalized fluorescent dye. Dodecyl isothiocyanate and 2-aminofluorene can be combined to make a functionalized fluorescent dye. Dodecyl isothiocyanate and 9-aminoacridine can be combined to make a functionalized fluorescent dye. Dodecyl isothiocyanate and 1,10-phenanthrolin-5-amine can be combined to make a functionalized fluorescent dye. Dodecyl isothiocyanate and 9H-carbazol-2-amine (hydrochloride) can be combined to make a functionalized fluorescent dye. Dodecyl isothiocyanate and 3-amino-9-ethylcarbazole can be combined to make a functionalized fluorescent dye. Tetradecyl isothiocyanate and 1-naphthylamine can be combined to make a functionalized fluorescent dye. Tetradecyl isothiocyanate and 2-aminoanthracene can be combined to make a functionalized fluorescent dye. Tetradecyl isothiocyanate and 1-aminopyrene can be combined to make a functionalized fluorescent dye. Tetradecyl isothiocyanate and 6-chrysenamine can be combined to make a functionalized fluorescent dye. Tetradecyl isothiocyanate and 9-aminophenanthrene can be combined to make a functionalized fluorescent dye. Tetradecyl isothiocyanate and 2-aminofluorene can be combined to make a functionalized fluorescent dye. Tetradecyl isothiocyanate and 9-aminoacridine can be combined to make a functionalized fluorescent dye. Tetradecyl isothiocyanate and 1,10-phenanthrolin-5-amine can be combined to make a functionalized fluorescent dye. Tetradecyl isothiocyanate and 9H-carbazol-2-amine (hydrochloride) can be combined to make a functionalized fluorescent dye. Tetradecyl isothiocyanate and 3-amino-9-ethylcarbazole can be combined to make a functionalized fluorescent dye. Hexadecyl isothiocyanate and 1-naphthylamine can be combined to make a functionalized fluorescent dye. Hexadecyl isothiocyanate and 2-aminoanthracene can be combined to make a functionalized fluorescent dye. Hexadecyl isothiocyanate and 1-aminopyrene can be combined to make a functionalized fluorescent dye. Hexadecyl isothiocyanate and 6-chrysenamine can be combined to make a functionalized fluorescent dye. Hexadecyl isothiocyanate and 9-aminophenanthrene can be combined to make a functionalized fluorescent dye. Hexadecyl isothiocyanate and 2-aminofluorene can be combined to make a functionalized fluorescent dye. Hexadecyl isothiocyanate and 9-aminoacridine can be combined to make a functionalized fluorescent dye. Hexadecyl isothiocyanate and 1,10-phenanthrolin-5-amine can be combined to make a functionalized fluorescent dye. Hexadecyl isothiocyanate and 9H-carbazol-2-amine (hydrochloride) can be combined to make a functionalized fluorescent dye. Hexadecyl isothiocyanate and 3-amino-9-ethylcarbazole can be combined to make a functionalized fluorescent dye. Octadecyl isothiocyanate and 1-naphthylamine can be combined to make a functionalized fluorescent dye. Octadecyl isothiocyanate and 2-aminoanthracene can be combined to make a functionalized fluorescent dye. Octadecyl isothiocyanate and 1-aminopyrene can be combined to make a functionalized fluorescent dye. Octadecyl isothiocyanate and 6-chrysenamine can be combined to make a functionalized fluorescent dye. Octadecyl isothiocyanate and 9-aminophenanthrene can be combined to make a functionalized fluorescent dye. Octadecyl isothiocyanate and 2-aminofluorene can be combined to make a functionalized fluorescent dye. Octadecyl isothiocyanate and 9-aminoacridine can be combined to make a functionalized fluorescent dye. Octadecyl isothiocyanate and 1,10-phenanthrolin-5-amine can be combined to make a functionalized fluorescent dye. Octadecyl isothiocyanate and 9H-carbazol-2-amine (hydrochloride) can be combined to make a functionalized fluorescent dye. Octadecyl isothiocyanate and 3-amino-9-ethylcarbazole can be combined to make a functionalized fluorescent dye.

Phenyl isothiocyanate and 1-naphthylamine can be combined to make a functionalized fluorescent dye. Phenyl isothiocyanate and 2-aminoanthracene can be combined to make a functionalized fluorescent dye. Phenyl isothiocyanate and 1-aminopyrene can be combined to make a functionalized fluorescent dye. Phenyl isothiocyanate and 6-chrysenamine can be combined to make a functionalized fluorescent dye. Phenyl isothiocyanate and 9-aminophenanthrene can be combined to make a functionalized fluorescent dye. Phenyl isothiocyanate and 2-aminofluorene can be combined to make a functionalized fluorescent dye. Phenyl isothiocyanate and 9-aminoacridine can be combined to make a functionalized fluorescent dye. Phenyl isothiocyanate and 1,10-phenanthrolin-5-amine can be combined to make a functionalized fluorescent dye. Phenyl isothiocyanate and 9H-carbazol-2-amine (hydrochloride) can be combined to make a functionalized fluorescent dye. Phenyl isothiocyanate and 3-amino-9-ethylcarbazole can be combined to make a functionalized fluorescent dye. Benzyl isothiocyanate and 1-naphthylamine can be combined to make a functionalized fluorescent dye. Benzyl isothiocyanate and 2-aminoanthracene can be combined to make a functionalized fluorescent dye. Benzyl isothiocyanate and 1-aminopyrene can be combined to make a functionalized fluorescent dye. Benzyl isothiocyanate and 6-chrysenamine can be combined to make a functionalized fluorescent dye. Benzyl isothiocyanate and 9-aminophenanthrene can be combined to make a functionalized fluorescent dye. Benzyl isothiocyanate and 2-aminofluorene can be combined to make a functionalized fluorescent dye. Benzyl isothiocyanate and 9-aminoacridine can be combined to make a functionalized fluorescent dye. Benzyl isothiocyanate and 1,10-phenanthrolin-5-amine can be combined to make a functionalized fluorescent dye. Benzyl isothiocyanate and 9H-carbazol-2-amine (hydrochloride) can be combined to make a functionalized fluorescent dye. Benzyl isothiocyanate and 3-amino-9-ethylcarbazole can be combined to make a functionalized fluorescent dye. Phenylethyl isothiocyanate and 1-naphthylamine can be combined to make a functionalized fluorescent dye. Phenylethyl isothiocyanate and 2-aminoanthracene can be combined to make a functionalized fluorescent dye. Phenylethyl isothiocyanate and 1-aminopyrene can be combined to make a functionalized fluorescent dye. Phenylethyl isothiocyanate and 6-chrysenamine can be combined to make a functionalized fluorescent dye. Phenylethyl isothiocyanate and 9-aminophenanthrene can be combined to make a functionalized fluorescent dye. Phenylethyl isothiocyanate and 2-aminofluorene can be combined to make a functionalized fluorescent dye. Phenylethyl isothiocyanate and 9-aminoacridine can be combined to make a functionalized fluorescent dye. Phenylethyl isothiocyanate and 1,10-phenanthrolin-5-amine can be combined to make a functionalized fluorescent dye. Phenylethyl isothiocyanate and 9H-carbazol-2-amine (hydrochloride) can be combined to make a functionalized fluorescent dye. Phenylethyl isothiocyanate and 3-amino-9-ethylcarbazole can be combined to make a functionalized fluorescent dye. Cyclohexyl isothiocyanate and 1-naphthylamine can be combined to make a functionalized fluorescent dye. Cyclohexyl isothiocyanate and 2-aminoanthracene can be combined to make a functionalized fluorescent dye. Cyclohexyl isothiocyanate and 1-aminopyrene can be combined to make a functionalized fluorescent dye. Cyclohexyl isothiocyanate and 6-chrysenamine can be combined to make a functionalized fluorescent dye. Cyclohexyl isothiocyanate and 9-aminophenanthrene can be combined to make a functionalized fluorescent dye. Cyclohexyl isothiocyanate and 2-aminofluorene can be combined to make a functionalized fluorescent dye. Cyclohexyl isothiocyanate and 9-aminoacridine can be combined to make a functionalized fluorescent dye. Cyclohexyl isothiocyanate and 1,10-phenanthrolin-5-amine can be combined to make a functionalized fluorescent dye. Cyclohexyl isothiocyanate and 9H-carbazol-2-amine (hydrochloride) can be combined to make a functionalized fluorescent dye. Cyclohexyl isothiocyanate and 3-amino-9-ethylcarbazole can be combined to make a functionalized fluorescent dye. Cyclohexylmethyl isothiocyanate and 1-naphthylamine can be combined to make a functionalized fluorescent dye. Cyclohexylmethyl isothiocyanate and 2-aminoanthracene can be combined to make a functionalized fluorescent dye. Cyclohexylmethyl isothiocyanate and 1-aminopyrene can be combined to make a functionalized fluorescent dye. Cyclohexylmethyl isothiocyanate and 6-chrysenamine can be combined to make a functionalized fluorescent dye. Cyclohexylmethyl isothiocyanate and 9-aminophenanthrene can be combined to make a functionalized fluorescent dye. Cyclohexylmethyl isothiocyanate and 2-aminofluorene can be combined to make a functionalized fluorescent dye. Cyclohexylmethyl isothiocyanate and 9-aminoacridine can be combined to make a functionalized fluorescent dye. Cyclohexylmethyl isothiocyanate and 1,10-phenanthrolin-5-amine can be combined to make a functionalized fluorescent dye. Cyclohexylmethyl isothiocyanate and 9H-carbazol-2-amine (hydrochloride) can be combined to make a functionalized fluorescent dye. Cyclohexylmethyl isothiocyanate and 3-amino-9-ethylcarbazole can be combined to make a functionalized fluorescent dye. 2-piperidinoethyl isothiocyanate and 1-naphthylamine can be combined to make a functionalized fluorescent dye. 2-piperidinoethyl isothiocyanate and 2-aminoanthracene can be combined to make a functionalized fluorescent dye. 2-piperidinoethyl isothiocyanate and 1-aminopyrene can be combined to make a functionalized fluorescent dye. 2-piperidinoethyl isothiocyanate and 6-chrysenamine can be combined to make a functionalized fluorescent dye. 2-piperidinoethyl isothiocyanate and 9-aminophenanthrene can be combined to make a functionalized fluorescent dye. 2-piperidinoethyl isothiocyanate and 2-aminofluorene can be combined to make a functionalized fluorescent dye. 2-piperidinoethyl isothiocyanate and 9-aminoacridine can be combined to make a functionalized fluorescent dye. 2-piperidinoethyl isothiocyanate and 1,10-phenanthrolin-5-amine can be combined to make a functionalized fluorescent dye. 2-piperidinoethyl isothiocyanate and 9H-carbazol-2-amine (hydrochloride) can be combined to make a functionalized fluorescent dye. 2-piperidinoethyl isothiocyanate and 3-amino-9-ethylcarbazole can be combined to make a functionalized fluorescent dye. p-Tolyl isothiocyanate and 1-naphthylamine can be combined to make a functionalized fluorescent dye. p-Tolyl isothiocyanate and 2-aminoanthracene can be combined to make a functionalized fluorescent dye. p-Tolyl isothiocyanate and 1-aminopyrene can be combined to make a functionalized fluorescent dye. p-Tolyl isothiocyanate and 6-chrysenamine can be combined to make a functionalized fluorescent dye. p-Tolyl isothiocyanate and 9-aminophenanthrene can be combined to make a functionalized fluorescent dye. p-Tolyl isothiocyanate and 2-aminofluorene can be combined to make a functionalized fluorescent dye. p-Tolyl isothiocyanate and 9-aminoacridine can be combined to make a functionalized fluorescent dye. p-Tolyl isothiocyanate and 1,10-phenanthrolin-5-amine can be combined to make a functionalized fluorescent dye. p-Tolyl isothiocyanate and 9H-carbazol-2-amine (hydrochloride) can be combined to make a functionalized fluorescent dye. p-Tolyl isothiocyanate and 3-amino-9-ethylcarbazole can be combined to make a functionalized fluorescent dye. 2,6-dimethylphenyl isothiocyanate and 1-naphthylamine can be combined to make a functionalized fluorescent dye. 2,6-dimethylphenyl isothiocyanate and 2-aminoanthracene can be combined to make a functionalized fluorescent dye. 2,6-dimethylphenyl isothiocyanate and 1-aminopyrene can be combined to make a functionalized fluorescent dye. 2,6-dimethylphenyl isothiocyanate and 6-chrysenamine can be combined to make a functionalized fluorescent dye. 2,6-dimethylphenyl isothiocyanate and 9-aminophenanthrene can be combined to make a functionalized fluorescent dye. 2,6-dimethylphenyl isothiocyanate and 2-aminofluorene can be combined to make a functionalized fluorescent dye. 2,6-dimethylphenyl isothiocyanate and 9-aminoacridine can be combined to make a functionalized fluorescent dye. 2,6-dimethylphenyl isothiocyanate and 1,10-phenanthrolin-5-amine can be combined to make a functionalized fluorescent dye. 2,6-dimethylphenyl isothiocyanate and 9H-carbazol-2-amine (hydrochloride) can be combined to make a functionalized fluorescent dye. 2,6-dimethylphenyl isothiocyanate and 3-amino-9-ethylcarbazole can be combined to make a functionalized fluorescent dye. 4-ethylphenyl isothiocyanate and 1-naphthylamine can be combined to make a functionalized fluorescent dye. 4-ethylphenyl isothiocyanate and 2-aminoanthracene can be combined to make a functionalized fluorescent dye. 4-ethylphenyl isothiocyanate and 1-aminopyrene can be combined to make a functionalized fluorescent dye. 4-ethylphenyl isothiocyanate and 6-chrysenamine can be combined to make a functionalized fluorescent dye. 4-ethylphenyl isothiocyanate and 9-aminophenanthrene can be combined to make a functionalized fluorescent dye. 4-ethylphenyl isothiocyanate and 2-aminofluorene can be combined to make a functionalized fluorescent dye. 4-ethylphenyl isothiocyanate and 9-aminoacridine can be combined to make a functionalized fluorescent dye. 4-ethylphenyl isothiocyanate and 1,10-phenanthrolin-5-amine can be combined to make a functionalized fluorescent dye. 4-ethylphenyl isothiocyanate and 9H-carbazol-2-amine (hydrochloride) can be combined to make a functionalized fluorescent dye. 4-ethylphenyl isothiocyanate and 3-amino-9-ethylcarbazole can be combined to make a functionalized fluorescent dye. 4-methoxyphenyl isothiocyanate and 1-naphthylamine can be combined to make a functionalized fluorescent dye. 4-methoxyphenyl isothiocyanate and 2-aminoanthracene can be combined to make a functionalized fluorescent dye. 4-methoxyphenyl isothiocyanate and 1-aminopyrene can be combined to make a functionalized fluorescent dye. 4-methoxyphenyl isothiocyanate and 6-chrysenamine can be combined to make a functionalized fluorescent dye. 4-methoxyphenyl isothiocyanate and 9-aminophenanthrene can be combined to make a functionalized fluorescent dye. 4-methoxyphenyl isothiocyanate and 2-aminofluorene can be combined to make a functionalized fluorescent dye. 4-methoxyphenyl isothiocyanate and 9-aminoacridine can be combined to make a functionalized fluorescent dye. 4-methoxyphenyl isothiocyanate and 1,10-phenanthrolin-5-amine can be combined to make a functionalized fluorescent dye. 4-methoxyphenyl isothiocyanate and 9H-carbazol-2-amine (hydrochloride) can be combined to make a functionalized fluorescent dye. 4-methoxyphenyl isothiocyanate and 3-amino-9-ethylcarbazole can be combined to make a functionalized fluorescent dye. 2,4-dimethoxyphenyl isothiocyanate and 1-naphthylamine can be combined to make a functionalized fluorescent dye. 2,4-dimethoxyphenyl isothiocyanate and 2-aminoanthracene can be combined to make a functionalized fluorescent dye. 2,4-dimethoxyphenyl isothiocyanate and 1-aminopyrene can be combined to make a functionalized fluorescent dye. 2,4-dimethoxyphenyl isothiocyanate and 6-chrysenamine can be combined to make a functionalized fluorescent dye. 2,4-dimethoxyphenyl isothiocyanate and 9-aminophenanthrene can be combined to make a functionalized fluorescent dye. 2,4-dimethoxyphenyl isothiocyanate and 2-aminofluorene can be combined to make a functionalized fluorescent dye. 2,4-dimethoxyphenyl isothiocyanate and 9-aminoacridine can be combined to make a functionalized fluorescent dye. 2,4-dimethoxyphenyl isothiocyanate and 1,10-phenanthrolin-5-amine can be combined to make a functionalized fluorescent dye. 2,4-dimethoxyphenyl isothiocyanate and 9H-carbazol-2-amine (hydrochloride) can be combined to make a functionalized fluorescent dye. 2,4-dimethoxyphenyl isothiocyanate and 3-amino-9-ethylcarbazole can be combined to make a functionalized fluorescent dye. 4-chlorophenyl isothiocyanate and 1-naphthylamine can be combined to make a functionalized fluorescent dye. 4-chlorophenyl isothiocyanate and 2-aminoanthracene can be combined to make a functionalized fluorescent dye. 4-chlorophenyl isothiocyanate and 1-aminopyrene can be combined to make a functionalized fluorescent dye. 4-chlorophenyl isothiocyanate and 6-chrysenamine can be combined to make a functionalized fluorescent dye. 4-chlorophenyl isothiocyanate and 9-aminophenanthrene can be combined to make a functionalized fluorescent dye. 4-chlorophenyl isothiocyanate and 2-aminofluorene can be combined to make a functionalized fluorescent dye. 4-chlorophenyl isothiocyanate and 9-aminoacridine can be combined to make a functionalized fluorescent dye. 4-chlorophenyl isothiocyanate and 1,10-phenanthrolin-5-amine can be combined to make a functionalized fluorescent dye. 4-chlorophenyl isothiocyanate and 9H-carbazol-2-amine (hydrochloride) can be combined to make a functionalized fluorescent dye. 4-chlorophenyl isothiocyanate and 3-amino-9-ethylcarbazole can be combined to make a functionalized fluorescent dye. 2,6-dichlorophenyl isothiocyanate and 1-naphthylamine can be combined to make a functionalized fluorescent dye. 2,6-dichlorophenyl isothiocyanate and 2-aminoanthracene can be combined to make a functionalized fluorescent dye. 2,6-dichlorophenyl isothiocyanate and 1-aminopyrene can be combined to make a functionalized fluorescent dye. 2,6-dichlorophenyl isothiocyanate and 6-chrysenamine can be combined to make a functionalized fluorescent dye. 2,6-dichlorophenyl isothiocyanate and 9-aminophenanthrene can be combined to make a functionalized fluorescent dye. 2,6-dichlorophenyl isothiocyanate and 2-aminofluorene can be combined to make a functionalized fluorescent dye. 2,6-dichlorophenyl isothiocyanate and 9-aminoacridine can be combined to make a functionalized fluorescent dye. 2,6-dichlorophenyl isothiocyanate and 1,10-phenanthrolin-5-amine can be combined to make a functionalized fluorescent dye. 2,6-dichlorophenyl isothiocyanate and 9H-carbazol-2-amine (hydrochloride) can be combined to make a functionalized fluorescent dye. 2,6-dichlorophenyl isothiocyanate and 3-amino-9-ethylcarbazole can be combined to make a functionalized fluorescent dye. 2,4,5-trichlorophenyl isothiocyanate and 1-naphthylamine can be combined to make a functionalized fluorescent dye. 2,4,5-trichlorophenyl isothiocyanate and 2-aminoanthracene can be combined to make a functionalized fluorescent dye. 2,4,5-trichlorophenyl isothiocyanate and 1-aminopyrene can be combined to make a functionalized fluorescent dye. 2,4,5-trichlorophenyl isothiocyanate and 6-chrysenamine can be combined to make a functionalized fluorescent dye. 2,4,5-trichlorophenyl isothiocyanate and 9-aminophenanthrene can be combined to make a functionalized fluorescent dye. 2,4,5-trichlorophenyl isothiocyanate and 2-aminofluorene can be combined to make a functionalized fluorescent dye. 2,4,5-trichlorophenyl isothiocyanate and 9-aminoacridine can be combined to make a functionalized fluorescent dye. 2,4,5-trichlorophenyl isothiocyanate and 1,10-phenanthrolin-5-amine can be combined to make a functionalized fluorescent dye. 2,4,5-trichlorophenyl isothiocyanate and 9H-carbazol-2-amine (hydrochloride) can be combined to make a functionalized fluorescent dye. 2,4,5-trichlorophenyl isothiocyanate and 3-amino-9-ethylcarbazole can be combined to make a functionalized fluorescent dye. 3-bromophenyl isothiocyanate and 1-naphthylamine can be combined to make a functionalized fluorescent dye. 3-bromophenyl isothiocyanate and 2-aminoanthracene can be combined to make a functionalized fluorescent dye. 3-bromophenyl isothiocyanate and 1-aminopyrene can be combined to make a functionalized fluorescent dye. 3-bromophenyl isothiocyanate and 6-chrysenamine can be combined to make a functionalized fluorescent dye. 3-bromophenyl isothiocyanate and 9-aminophenanthrene can be combined to make a functionalized fluorescent dye. 3-bromophenyl isothiocyanate and 2-aminofluorene can be combined to make a functionalized fluorescent dye. 3-bromophenyl isothiocyanate and 9-aminoacridine can be combined to make a functionalized fluorescent dye. 3-bromophenyl isothiocyanate and 1,10-phenanthrolin-5-amine can be combined to make a functionalized fluorescent dye. 3-bromophenyl isothiocyanate and 9H-carbazol-2-amine (hydrochloride) can be combined to make a functionalized fluorescent dye. 3-bromophenyl isothiocyanate and 3-amino-9-ethylcarbazole can be combined to make a functionalized fluorescent dye. 2,5-dibromophenyl isothiocyanate and 1-naphthylamine can be combined to make a functionalized fluorescent dye. 2,5-dibromophenyl isothiocyanate and 2-aminoanthracene can be combined to make a functionalized fluorescent dye. 2,5-dibromophenyl isothiocyanate and 1-aminopyrene can be combined to make a functionalized fluorescent dye. 2,5-dibromophenyl isothiocyanate and 6-chrysenamine can be combined to make a functionalized fluorescent dye. 2,5-dibromophenyl isothiocyanate and 9-aminophenanthrene can be combined to make a functionalized fluorescent dye. 2,5-dibromophenyl isothiocyanate and 2-aminofluorene can be combined to make a functionalized fluorescent dye. 2,5-dibromophenyl isothiocyanate and 9-aminoacridine can be combined to make a functionalized fluorescent dye. 2,5-dibromophenyl isothiocyanate and 1,10-phenanthrolin-5-amine can be combined to make a functionalized fluorescent dye. 2,5-dibromophenyl isothiocyanate and 9H-carbazol-2-amine (hydrochloride) can be combined to make a functionalized fluorescent dye. 2,5-dibromophenyl isothiocyanate and 3-amino-9-ethylcarbazole can be combined to make a functionalized fluorescent dye. 2,4,6-tribromophenyl isothiocyanate and 1-naphthylamine can be combined to make a functionalized fluorescent dye. 2,4,6-tribromophenyl isothiocyanate and 2-aminoanthracene can be combined to make a functionalized fluorescent dye. 2,4,6-tribromophenyl isothiocyanate and 1-aminopyrene can be combined to make a functionalized fluorescent dye. 2,4,6-tribromophenyl isothiocyanate and 6-chrysenamine can be combined to make a functionalized fluorescent dye. 2,4,6-tribromophenyl isothiocyanate and 9-aminophenanthrene can be combined to make a functionalized fluorescent dye. 2,4,6-tribromophenyl isothiocyanate and 2-aminofluorene can be combined to make a functionalized fluorescent dye. 2,4,6-tribromophenyl isothiocyanate and 9-aminoacridine can be combined to make a functionalized fluorescent dye. 2,4,6-tribromophenyl isothiocyanate and 1,10-phenanthrolin-5-amine can be combined to make a functionalized fluorescent dye. 2,4,6-tribromophenyl isothiocyanate and 9H-carbazol-2-amine (hydrochloride) can be combined to make a functionalized fluorescent dye. 2,4,6-tribromophenyl isothiocyanate and 3-amino-9-ethylcarbazole can be combined to make a functionalized fluorescent dye. 3-fluorophenyl isothiocyanate and 1-naphthylamine can be combined to make a functionalized fluorescent dye. 3-fluorophenyl isothiocyanate and 2-aminoanthracene can be combined to make a functionalized fluorescent dye. 3-fluorophenyl isothiocyanate and 1-aminopyrene can be combined to make a functionalized fluorescent dye. 3-fluorophenyl isothiocyanate and 6-chrysenamine can be combined to make a functionalized fluorescent dye. 3-fluorophenyl isothiocyanate and 9-aminophenanthrene can be combined to make a functionalized fluorescent dye. 3-fluorophenyl isothiocyanate and 2-aminofluorene can be combined to make a functionalized fluorescent dye. 3-fluorophenyl isothiocyanate and 9-aminoacridine can be combined to make a functionalized fluorescent dye. 3-fluorophenyl isothiocyanate and 1,10-phenanthrolin-5-amine can be combined to make a functionalized fluorescent dye. 3-fluorophenyl isothiocyanate and 9H-carbazol-2-amine (hydrochloride) can be combined to make a functionalized fluorescent dye. 3-fluorophenyl isothiocyanate and 3-amino-9-ethylcarbazole can be combined to make a functionalized fluorescent dye. 2,6-difluorophenyl isothiocyanate and 1-naphthylamine can be combined to make a functionalized fluorescent dye. 2,6-difluorophenyl isothiocyanate and 2-aminoanthracene can be combined to make a functionalized fluorescent dye. 2,6-difluorophenyl isothiocyanate and 1-aminopyrene can be combined to make a functionalized fluorescent dye. 2,6-difluorophenyl isothiocyanate and 6-chrysenamine can be combined to make a functionalized fluorescent dye. 2,6-difluorophenyl isothiocyanate and 9-aminophenanthrene can be combined to make a functionalized fluorescent dye. 2,6-difluorophenyl isothiocyanate and 2-aminofluorene can be combined to make a functionalized fluorescent dye. 2,6-difluorophenyl isothiocyanate and 9-aminoacridine can be combined to make a functionalized fluorescent dye. 2,6-difluorophenyl isothiocyanate and 1,10-phenanthrolin-5-amine can be combined to make a functionalized fluorescent dye. 2,6-difluorophenyl isothiocyanate and 9H-carbazol-2-amine (hydrochloride) can be combined to make a functionalized fluorescent dye. 2,6-difluorophenyl isothiocyanate and 3-amino-9-ethylcarbazole can be combined to make a functionalized fluorescent dye. 2,4,6-trifluorophenyl isothiocyanate and 1-naphthylamine can be combined to make a functionalized fluorescent dye. 2,4,6-trifluorophenyl isothiocyanate and 2-aminoanthracene can be combined to make a functionalized fluorescent dye. 2,4,6-trifluorophenyl isothiocyanate and 1-aminopyrene can be combined to make a functionalized fluorescent dye. 2,4,6-trifluorophenyl isothiocyanate and 6-chrysenamine can be combined to make a functionalized fluorescent dye. 2,4,6-trifluorophenyl isothiocyanate and 9-aminophenanthrene can be combined to make a functionalized fluorescent dye. 2,4,6-trifluorophenyl isothiocyanate and 2-aminofluorene can be combined to make a functionalized fluorescent dye. 2,4,6-trifluorophenyl isothiocyanate and 9-aminoacridine can be combined to make a functionalized fluorescent dye. 2,4,6-trifluorophenyl isothiocyanate and 1,10-phenanthrolin-5-amine can be combined to make a functionalized fluorescent dye. 2,4,6-trifluorophenyl isothiocyanate and 9H-carbazol-2-amine (hydrochloride) can be combined to make a functionalized fluorescent dye. 2,4,6-trifluorophenyl isothiocyanate and 3-amino-9-ethylcarbazole can be combined to make a functionalized fluorescent dye. 4-(Trifluoromethyl)phenyl isothiocyanate and 1-naphthylamine can be combined to make a functionalized fluorescent dye. 4-(Trifluoromethyl)phenyl isothiocyanate and 2-aminoanthracene can be combined to make a functionalized fluorescent dye. 4-(Trifluoromethyl)phenyl isothiocyanate and 1-aminopyrene can be combined to make a functionalized fluorescent dye. 4-(Trifluoromethyl)phenyl isothiocyanate and 6-chrysenamine can be combined to make a functionalized fluorescent dye. 4-(Trifluoromethyl)phenyl isothiocyanate and 9-aminophenanthrene can be combined to make a functionalized fluorescent dye. 4-(Trifluoromethyl)phenyl isothiocyanate and 2-aminofluorene can be combined to make a functionalized fluorescent dye. 4-(Trifluoromethyl)phenyl isothiocyanate and 9-aminoacridine can be combined to make a functionalized fluorescent dye. 4-(Trifluoromethyl)phenyl isothiocyanate and 1,10-phenanthrolin-5-amine can be combined to make a functionalized fluorescent dye. 4-(Trifluoromethyl)phenyl isothiocyanate and 9H-carbazol-2-amine (hydrochloride) can be combined to make a functionalized fluorescent dye. 4-(Trifluoromethyl)phenyl isothiocyanate and 3-amino-9-ethylcarbazole can be combined to make a functionalized fluorescent dye. 3,5-Bis(trifluoromethyl)phenyl isothiocyanate and 1-naphthylamine can be combined to make a functionalized fluorescent dye. 3,5-Bis(trifluoromethyl)phenyl isothiocyanate and 2-aminoanthracene can be combined to make a functionalized fluorescent dye. 3,5-Bis(trifluoromethyl)phenyl isothiocyanate and 1-aminopyrene can be combined to make a functionalized fluorescent dye. 3,5-Bis(trifluoromethyl)phenyl isothiocyanate and 6-chrysenamine can be combined to make a functionalized fluorescent dye. 3,5-Bis(trifluoromethyl)phenyl isothiocyanate and 9-aminophenanthrene can be combined to make a functionalized fluorescent dye. 3,5-Bis(trifluoromethyl)phenyl isothiocyanate and 2-aminofluorene can be combined to make a functionalized fluorescent dye. 3,5-Bis(trifluoromethyl)phenyl isothiocyanate and 9-aminoacridine can be combined to make a functionalized fluorescent dye. 3,5-Bis(trifluoromethyl)phenyl isothiocyanate and 1,10-phenanthrolin-5-amine can be combined to make a functionalized fluorescent dye. 3,5-Bis(trifluoromethyl)phenyl isothiocyanate and 9H-carbazol-2-amine (hydrochloride) can be combined to make a functionalized fluorescent dye. 3,5-Bis(trifluoromethyl)phenyl isothiocyanate and 3-amino-9-ethylcarbazole can be combined to make a functionalized fluorescent dye. 2-Chloro-5-(trifluoromethyl)phenyl isothiocyanate and 1-naphthylamine can be combined to make a functionalized fluorescent dye. 2-Chloro-5-(trifluoromethyl)phenyl isothiocyanate and 2-aminoanthracene can be combined to make a functionalized fluorescent dye. 2-Chloro-5-(trifluoromethyl)phenyl isothiocyanate and 1-aminopyrene can be combined to make a functionalized fluorescent dye. 2-Chloro-5-(trifluoromethyl)phenyl isothiocyanate and 6-chrysenamine can be combined to make a functionalized fluorescent dye. 2-Chloro-5-(trifluoromethyl)phenyl isothiocyanate and 9-aminophenanthrene can be combined to make a functionalized fluorescent dye. 2-Chloro-5-(trifluoromethyl)phenyl isothiocyanate and 2-aminofluorene can be combined to make a functionalized fluorescent dye. 2-Chloro-5-(trifluoromethyl)phenyl isothiocyanate and 9-aminoacridine can be combined to make a functionalized fluorescent dye. 2-Chloro-5-(trifluoromethyl)phenyl isothiocyanate and 1,10-phenanthrolin-5-amine can be combined to make a functionalized fluorescent dye. 2-Chloro-5-(trifluoromethyl)phenyl isothiocyanate and 9H-carbazol-2-amine (hydrochloride) can be combined to make a functionalized fluorescent dye. 2-Chloro-5-(trifluoromethyl)phenyl isothiocyanate and 3-amino-9-ethylcarbazole can be combined to make a functionalized fluorescent dye. 4-Bromo-2-(trifluoromethyl)phenyl isothiocyanate and 1-naphthylamine can be combined to make a functionalized fluorescent dye. 4-Bromo-2-(trifluoromethyl)phenyl isothiocyanate and 2-aminoanthracene can be combined to make a functionalized fluorescent dye. 4-Bromo-2-(trifluoromethyl)phenyl isothiocyanate and 1-aminopyrene can be combined to make a functionalized fluorescent dye. 4-Bromo-2-(trifluoromethyl)phenyl isothiocyanate and 6-chrysenamine can be combined to make a functionalized fluorescent dye. 4-Bromo-2-(trifluoromethyl)phenyl isothiocyanate and 9-aminophenanthrene can be combined to make a functionalized fluorescent dye. 4-Bromo-2-(trifluoromethyl)phenyl isothiocyanate and 2-aminofluorene can be combined to make a functionalized fluorescent dye. 4-Bromo-2-(trifluoromethyl)phenyl isothiocyanate and 9-aminoacridine can be combined to make a functionalized fluorescent dye. 4-Bromo-2-(trifluoromethyl)phenyl isothiocyanate and 1,10-phenanthrolin-5-amine can be combined to make a functionalized fluorescent dye. 4-Bromo-2-(trifluoromethyl)phenyl isothiocyanate and 9H-carbazol-2-amine (hydrochloride) can be combined to make a functionalized fluorescent dye. 4-Bromo-2-(trifluoromethyl)phenyl isothiocyanate and 3-amino-9-ethylcarbazole can be combined to make a functionalized fluorescent dye. 4-Fluoro-3-(trifluoromethyl)phenyl isothiocyanate and 1-naphthylamine can be combined to make a functionalized fluorescent dye. 4-Fluoro-3-(trifluoromethyl)phenyl isothiocyanate and 2-aminoanthracene can be combined to make a functionalized fluorescent dye. 4-Fluoro-3-(trifluoromethyl)phenyl isothiocyanate and 1-aminopyrene can be combined to make a functionalized fluorescent dye. 4-Fluoro-3-(trifluoromethyl)phenyl isothiocyanate and 6-chrysenamine can be combined to make a functionalized fluorescent dye. 4-Fluoro-3-(trifluoromethyl)phenyl isothiocyanate and 9-aminophenanthrene can be combined to make a functionalized fluorescent dye. 4-Fluoro-3-(trifluoromethyl)phenyl isothiocyanate and 2-aminofluorene can be combined to make a functionalized fluorescent dye. 4-Fluoro-3-(trifluoromethyl)phenyl isothiocyanate and 9-aminoacridine can be combined to make a functionalized fluorescent dye. 4-Fluoro-3-(trifluoromethyl)phenyl isothiocyanate and 1,10-phenanthrolin-5-amine can be combined to make a functionalized fluorescent dye. 4-Fluoro-3-(trifluoromethyl)phenyl isothiocyanate and 9H-carbazol-2-amine (hydrochloride) can be combined to make a functionalized fluorescent dye. 4-Fluoro-3-(trifluoromethyl)phenyl isothiocyanate and 3-amino-9-ethylcarbazole can be combined to make a functionalized fluorescent dye. 3-Chloro-4-fluorophenyl isothiocyanate and 1-naphthylamine can be combined to make a functionalized fluorescent dye. 3-Chloro-4-fluorophenyl isothiocyanate and 2-aminoanthracene can be combined to make a functionalized fluorescent dye. 3-Chloro-4-fluorophenyl isothiocyanate and 1-aminopyrene can be combined to make a functionalized fluorescent dye. 3-Chloro-4-fluorophenyl isothiocyanate and 6-chrysenamine can be combined to make a functionalized fluorescent dye. 3-Chloro-4-fluorophenyl isothiocyanate and 9-aminophenanthrene can be combined to make a functionalized fluorescent dye. 3-Chloro-4-fluorophenyl isothiocyanate and 2-aminofluorene can be combined to make a functionalized fluorescent dye. 3-Chloro-4-fluorophenyl isothiocyanate and 9-aminoacridine can be combined to make a functionalized fluorescent dye. 3-Chloro-4-fluorophenyl isothiocyanate and 1,10-phenanthrolin-5-amine can be combined to make a functionalized fluorescent dye. 3-Chloro-4-fluorophenyl isothiocyanate and 9H-carbazol-2-amine (hydrochloride) can be combined to make a functionalized fluorescent dye. 3-Chloro-4-fluorophenyl isothiocyanate and 3-amino-9-ethylcarbazole can be combined to make a functionalized fluorescent dye. 2-Bromo-4-fluorophenyl isothiocyanate and 1-naphthylamine can be combined to make a functionalized fluorescent dye. 2-Bromo-4-fluorophenyl isothiocyanate and 2-aminoanthracene can be combined to make a functionalized fluorescent dye. 2-Bromo-4-fluorophenyl isothiocyanate and 1-aminopyrene can be combined to make a functionalized fluorescent dye. 2-Bromo-4-fluorophenyl isothiocyanate and 6-chrysenamine can be combined to make a functionalized fluorescent dye. 2-Bromo-4-fluorophenyl isothiocyanate and 9-aminophenanthrene can be combined to make a functionalized fluorescent dye. 2-Bromo-4-fluorophenyl isothiocyanate and 2-aminofluorene can be combined to make a functionalized fluorescent dye. 2-Bromo-4-fluorophenyl isothiocyanate and 9-aminoacridine can be combined to make a functionalized fluorescent dye. 2-Bromo-4-fluorophenyl isothiocyanate and 1,10-phenanthrolin-5-amine can be combined to make a functionalized fluorescent dye. 2-Bromo-4-fluorophenyl isothiocyanate and 9H-carbazol-2-amine (hydrochloride) can be combined to make a functionalized fluorescent dye. 2-Bromo-4-fluorophenyl isothiocyanate and 3-amino-9-ethylcarbazole can be combined to make a functionalized fluorescent dye. 4-Bromo-2-chlorophenyl isothiocyanate and 1-naphthylamine can be combined to make a functionalized fluorescent dye. 4-Bromo-2-chlorophenyl isothiocyanate and 2-aminoanthracene can be combined to make a functionalized fluorescent dye. 4-Bromo-2-chlorophenyl isothiocyanate and 1-aminopyrene can be combined to make a functionalized fluorescent dye. 4-Bromo-2-chlorophenyl isothiocyanate and 6-chrysenamine can be combined to make a functionalized fluorescent dye. 4-Bromo-2-chlorophenyl isothiocyanate and 9-aminophenanthrene can be combined to make a functionalized fluorescent dye. 4-Bromo-2-chlorophenyl isothiocyanate and 2-aminofluorene can be combined to make a functionalized fluorescent dye. 4-Bromo-2-chlorophenyl isothiocyanate and 9-aminoacridine can be combined to make a functionalized fluorescent dye. 4-Bromo-2-chlorophenyl isothiocyanate and 1,10-phenanthrolin-5-amine can be combined to make a functionalized fluorescent dye. 4-Bromo-2-chlorophenyl isothiocyanate and 9H-carbazol-2-amine (hydrochloride) can be combined to make a functionalized fluorescent dye. 4-Bromo-2-chlorophenyl isothiocyanate and 3-amino-9-ethylcarbazole can be combined to make a functionalized fluorescent dye.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

The term “downhole” as used in this disclosure refers to under the surface of the earth, such as a location within or fluidly connected to a wellbore.

As used in this disclosure, the term “drilling fluid” refers to fluids, slurries, or muds used in drilling operations downhole, such as during the formation of the wellbore.

As used in this disclosure, the term “fluid” refers to gases, liquids, gels, and any combination of these, unless otherwise indicated.

As used in this disclosure, the term “subterranean material” or “subterranean zone” or “subterranean formation” refers to any material under the surface of the earth, including under the surface of the bottom of the ocean. For example, a subterranean zone or material can be any section of a wellbore and any section of a subterranean petroleum-or water-producing formation or region in fluid contact with the wellbore. Placing a material in a subterranean zone can include contacting the material with any section of a wellbore or with any subterranean region in fluid contact the material. Subterranean materials can include any materials placed into the wellbore such as cement, drill shafts, liners, tubing, casing, or screens; placing a material in a subterranean zone can include contacting with such subterranean materials. In some examples, a subterranean zone or material can be any downhole region that can produce liquid and/or gaseous petroleum materials, water, or any downhole section in fluid contact with liquid or gaseous petroleum materials, or water. For example, a subterranean zone or material can be at least one of an area desired to be fractured, a fracture or an area surrounding a fracture, and a flow pathway or an area surrounding a flow pathway, in which a fracture or a flow pathway can be optionally fluidly connected to a subterranean petroleum-or water-producing region, directly or through one or more fractures or flow pathways.

As used in this disclosure, “treatment of a subterranean zone” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, aquifer remediation, identifying oil rich regions via imaging techniques, and the like.

As used in this disclosure, a “flow pathway” downhole can include any suitable subterranean flow pathway through which two subterranean locations are in fluid connection. The flow pathway can be sufficient for petroleum and/or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some implementations, a flow pathway can be a water source and can include water. In some implementations, a flow pathway can be a petroleum source and can include petroleum. In some implementations, a flow pathway can be sufficient to divert water, a downhole fluid, or a produced hydrocarbon from a wellbore, fracture, or flow pathway connected to the pathway.

As used in this disclosure, “weight percent” (wt. %) can be considered a mass fraction or a mass ratio of a substance to the total mixture or composition. Weight percent can be a weight-to-weight ratio or mass-to-mass ratio, unless indicated otherwise.

As used in this disclosure, the abbreviation “MW” refers to molecular weight in daltons.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method of making a functionalized fluorescent dye, comprising:
dissolving an oil-soluble isothiocyanate-containing compound in a first portion of a first organic solvent to yield a first solution, wherein the oil-soluble isothiocyanate-containing compound is selected from the group consisting of methyl isothiocyanate, ethyl isothiocyanate, propyl isothiocyanate, isopropyl isothiocyanate, butyl isothiocyanate, tert-butyl isothiocyanate, hexyl isothiocyanate, octyl isothiocyanate, decyl isothiocyanate, dodectyl isothiocyanate, tetradecyl isothiocyanate, hexadecyl isothiocyanate, octadecyl isothiocyanate, phenyl isothiocyanate, benzyl isothiocyanate, phenylethyl isothiocyanate, cyclohexyl isothiocyanate, cyclohexylmethyl isothiocyanate, 2-piperidinoethyl isothiocyanate, p-tolyl isothiocyanate, 2,6-dimethylphenyl isothiocyanate, 4-ethylphenyl isothiocyanate, 4-methoxyphenyl isothiocyanate, 2,4-dimethoxyphenyl isothiocyanate, 4-chlorophenyl isothiocyanate, 2,6-dichlorophenyl isothiocyanate, 2,4,5-trichlorophenyl isothiocyanate, 3-bromophenyl isothiocyanate, 2,5-dibromophenyl isothiocyanate, 2,4,6-tribromophenyl isothiocyanate, 3-fluorophenyl isothiocyanate, 2,6-difluorophenyl isothiocyanate, 2,4,6-trifluorophenyl isothiocyanate, 4-(trifluoromethyl)phenyl isothiocyanate, 3,5-bis(trifluoromethyl)phenyl isothiocyanate, 2-chloro-5-(trifluoromethyl)phenyl isothiocyanate, 4-bromo-2-(trifluoromethyl)phenyl isothiocyanate, 4-fluoro-3-(trifluoromethyl)phenyl isothiocyanate, 3-chloro-4-fluorophenyl isothiocyanate, 2-bromo-4-fluorophenyl isothiocyanate, or 4-bromo-2-chlorophenyl isothiocyanate, or any isoform thereof;
dissolving a functional group in a second portion of the first organic solvent to yield a second solution, wherein the functional group comprises a primary amine and is selected from the group consisting of 1-naphthylamine, 2-aminoanthracene, 1-aminopyrene, 6-chrysenamine, 9-aminophenanthrene, 2-aminofluorene, 9-aminoacridine, 1,10-phenanthrolin-5-amine, 9H-carbazol-2-amine, or 3-amino-9-ethylcarbazole;
mixing the first solution and the second solution to form a reaction mixture; and
extracting the functionalized fluorescent dye from the reaction mixture, wherein the functionalized fluorescent dye is a reaction product of the oil-soluble isothiocyanate-containing compound and the functional group.

2. The method of claim 1, wherein the first organic solvent comprises methanol, ethanol, propanol, isopropanol, chloroform, dichloromethane, acetone, cyclohexane, hexane, benzene, toluene or any combination thereof.

3. The method of claim 1, wherein extracting the functionalized fluorescent dye from the reaction mixture comprises evaporating the first organic solvent.

4. The method of claim 3, comprising, after extracting the functionalized fluorescent dye from the reaction mixture, re-dispersing the functionalized fluorescent dye in a second organic solvent.

5. The method of claim 4, wherein the second organic solvent comprises crude oil, diesel, mineral oil, food oil, methanol, ethanol, propanol, isopropanol, butanol, pentanol, hexanol, heptanol, octenol, acetone, ethyl acetate, acetonitrile, chloroform, hexane, heptane, cyclohexane, benzene, toluene, tetrahydrofuran, or any combination thereof.

6. The method of claim 5, wherein the second organic solvent has a composition different from the composition of the first organic solvent.

7. A method of tracing fluid flow in a subterranean formation, comprising:
mixing a functionalized fluorescent tracer and a fluid to form a tracer fluid, wherein the functionalized fluorescent tracer comprises an isothiocyanate-containing compound functionalized with a functional group comprising a primary amine, wherein:
the isothiocyanate-containing compound is selected from the group consisting of methyl isothiocyanate, ethyl isothiocyanate, propyl isothiocyanate, isopropyl isothiocyanate, butyl isothiocyanate, tert-butyl isothiocyanate, hexyl isothiocyanate, octyl isothiocyanate, decyl isothiocyanate, dodectyl isothiocyanate, tetradecyl isothiocyanate, hexadecyl isothiocyanate, octadecyl isothiocyanate, phenyl isothiocyanate, benzyl isothiocyanate, phenylethyl isothiocyanate, cyclohexyl isothiocyanate, cyclohexylmethyl isothiocyanate, 2-piperidinoethyl isothiocyanate, p-tolyl isothiocyanate, 2,6-dimethylphenyl isothiocyanate, 4-ethylphenyl isothiocyanate, 4-methoxyphenyl isothiocyanate, 2,4-dimethoxyphenyl isothiocyanate, 4-chlorophenyl isothiocyanate, 2,6-dichlorophenyl isothiocyanate, 2,4,5-trichlorophenyl isothiocyanate, 3-bromophenyl isothiocyanate, 2,5-dibromophenyl isothiocyanate, 2,4,6-tribromophenyl isothiocyanate, 3-fluorophenyl isothiocyanate, 2,6-difluorophenyl isothiocyanate, 2,4,6-trifluorophenyl isothiocyanate, 4-(trifluoromethyl)phenyl isothiocyanate, 3,5-bis(trifluoromethyl)phenyl isothiocyanate, 2-chloro-5-(trifluoromethyl)phenyl isothiocyanate, 4-bromo-2-(trifluoromethyl)phenyl isothiocyanate, 4-fluoro-3-(trifluoromethyl)phenyl isothiocyanate, 3-chloro-4-fluorophenyl isothiocyanate, 2-bromo-4-fluorophenyl isothiocyanate, or 4-bromo-2-chlorophenyl isothiocyanate, or any isoform thereof; and
the functional group is selected from the group consisting of 1-naphthylamine, 2-aminoanthracene, 1-aminopyrene, 6-chrysenamine, 9-aminophenanthrene, 2-aminofluorene, 9-aminoacridine, 1,10-phenanthrolin-5-amine, 9H-carbazol-2-amine, or 3-amino-9-ethylcarbazole;
flowing the tracer fluid into a first subterranean formation;
recovering a sample from the first subterranean formation or a second subterranean formation connected to the first subterranean formation; and
analyzing the sample for a fluorescent signal.

8. The method of claim 7, comprising identifying the functionalized fluorescent tracer in the sample using fluorescence, ultraviolet-visible (UV-Vis) spectroscopy, Fourier-transform infrared spectroscopy (FTIR), Raman spectroscopy, mass spectroscopy (MS), high performance liquid chromatography (HPLC), or liquid chromatography-mass spectroscopy (LC-MS), or any combination thereof.

9. The method of claim 7, where in the sample is a fluid sample.

10. The method of claim 7, wherein the sample is a solid sample.

11. The method of claim 7, wherein the fluid is a fracking fluid.

12. The method of claim 7, wherein the fluid is a drilling mud.

13. The method of claim 7, comprising analyzing the sample for a barcode structure and identifying the isothiocyanate-containing compound of the functionalized fluorescent tracer based on the barcode structure.
